(19) United States
(12) Patent Application Publication
(10) Pub. No.: US 2014/0147646 A1
(43) Pub. Date: May 29, 2014

(54) Polymeric Films and Methods to Manufacture The Same

(71) Applicants: Xin Chen, Shanghai (CN); Hardy Philippe, Gembloux (BE)

(72) Inventors: Xin Chen, Shanghai (CN); Hardy Philippe, Gembloux (BE)

(73) Assignee: ExxonMobil Chemical Patents Inc., Baytown, TX (US)

(21) Appl. No.: 13/880,383

(22) PCT Filed: Nov. 5, 2010
(86) PCT No.: PCT/CN2010/001778

§ 371 Date: Jul. 3, 2013

(51) Int. Cl. B32B 27/08; B29C 47/06; B32B 27/32; B29C 47/00

(52) U.S. Cl. CPC B32B 27/08; B29C 47/0057; B29C 47/065; B32B 27/32; B32B 27/327
USPC 428/218; 264/510; 428/516; 428/517

(57) ABSTRACT

In one aspect, the disclosure relates to multilayer polymeric films comprising: at least one layer A, and at least one layer B; wherein at least one of layers A and B further comprises at least one copolymer of propylene derived units and one or more C₂, and C₄ to C₁₀ alpha-olefin derived units, the copolymer having: (a) a C₂, and/or C₄ to C₁₀ alpha-olefin derived unit content in the range of about 5 to 30 weight %; (b) an intermolecular composition distribution of greater than or equal to 75%; (c) a Tm in the range of from about 25° C. to about 110° C.; (d) a Hf in the range of from about 0.5 to about 70 J/g; (e) a Mw/Mn in the range of from about 1.2 to about 4.5; and (f) a MFR in the range of from about 0.1 to about 40 g/10 min; and wherein the multilayer polymeric film has a seal strength greater than 6.25 N/cm, at a dwell time of 0.75 seconds.

### PRIORITY CLAIM

The present application claims priority to and the benefit of International Application No. PCT/CN2010/001778 filed on Nov. 5, 2010 and entitled, “Polymeric Films and Methods to Manufacture the Same”, the disclosure of which is hereby incorporated by reference herein its entirety.

### FIELD OF THE INVENTION

The present invention relates to polymeric films. More particularly, the invention relates to multilayer polymeric films useful for blown film applications.

### BACKGROUND OF THE INVENTION

Polymeric films are used in a variety of blown film applications, such as for shrink wrapping films, display wrapping films, flexible overwrap and packaging, pre-made bags, printing films, and so on. A variety of products may be enclosed in shrink wrap to stabilize the products, unitize them, keep them clean, add a degree of tamper resistance, etc. Important film properties include good mechanical properties (or toughness), good optical properties (especially haze), good processability, and low shrinkage temperature. Mechanical and optical properties of films, as well as processability, vary considerably depending on a number of factors inclusive of film composition, that is polymer composing the film, catalyst used to produce the polymer, method of manufacture and so on. Improved mechanical properties such as elongation at break, tensile strength at break, dart impact strength, and puncture resistance are desired to ensure package integrity, especially during packaging and transportation. Improved optical properties such as low haze, high gloss, and improved transparency or clarity are also desirable in the end use product. Good processability and low shrinkage temperature are particularly desired because these ensure high packaging speed and fast shrinkage which are invaluable in blown film applications. Due to the widespread use and numerous applications of polymeric films, it is of industrial importance to improve film properties and process efficiency, especially where cost and energy savings are achieved due to these improvements.

Traditionally, “low shrinkage temperature” biaxially oriented shrinkage films were produced from ULDPE (ultra low density polyethylene), EVA, EBA, and other materials with low melting points. These materials are very soft, and films made from these materials possess low modulus. The low modulus of the film reduces processability and therefore restricts packaging speed. Therefore, there remains a need for films useful for blown film applications that possess good mechanical properties, good processability, and low shrinkage temperature to ensure high packaging speed and fast shrinkage.

Commercial multilayer polymeric films used in blown film applications often use propylene-based polymers in the outer or “skin” layers. Such propylene-based polymers typically include terpolymers. In some countries, there is a limited terpolymer supply. Accordingly, alternatives to terpolymer in the skin layer, which maintain or improve the film properties, are desired.

International Publication No. WO 2008/017244 discloses films comprising at least three layers, an inner layer and at least two outer layers, located at opposite surfaces of the inner layer, where the inner layer is formed from a composition comprising an ethylene-based interpolymer, which has a density from 0.87 g/cc to 0.94 g/cc, and a melt index (I2) from 0.5 g/10 min to 10 g/10 min, and wherein at least one outer layer is formed from a composition comprising a propylene-based interpolymer, which has a density from 0.86 g/cc to 0.89 g/cc, and a melt flow rate (MFR) from 1 g/10 min to 15 g/10 min.

Some other examples of films in the art are described in U.S. Pat. Nos. 4,354,997; 4,532,189; 4,801,652; 4,814,135; 4,820,557; 4,833,024; 5,051,481; 5,306,549; 5,614,315; and 6,344,250; International Publication Nos. WO 02/45957; WO 03/040202; WO 89/01402; WO 91/17886; WO 01/53079; WO 05/103123; WO 2004/078829; WO 2005/097493; and WO 2007/058783; EP Patent Nos. 0350859B1; EP 0388177B1; EP 1318173A1; EP 0595701B1; and EP 0710546B1.

There remains a need for blown films having improved mechanical and optical properties (such as seal strength, dart impact strength, puncture resistance, superior shrink levels at low temperatures, and improved interlayer adhesion) that also demonstrate good processability and orientation stability.

### SUMMARY OF THE INVENTION

In one aspect, the disclosure relates to multilayer polymeric films comprising: at least one layer A, comprising a first polymeric resin, the first polymeric resin comprising propylene derived units and having: (a) a propylene derived unit content of greater than 90 weight %, based on the weight of the first polymeric resin; (b) a Tm of greater than 120° C.; and (c) a MFR in the range of from about 0.1 to about 100 g/10 min; and at least one layer B, comprising a second polymeric resin, the second polymeric resin comprising ethylene derived units and having: (a) a density in the range of about 0.905 to about 0.945 g/cm³; (b) an ethylene derived unit content of greater than 50 weight %, based on the weight of the second polymeric resin; (c) a CDBI of greater than 50%; (d) a MI in the range of about 0.1 to about 5.0 g/10 min; and (e) a g′ of greater than about 0.7; and wherein at least one of layers A and B further comprises at least one copolymer of propylene derived units and one or more C₂, and C₄ to C₁₀ alpha-olefin derived units, the copolymer having: (a) a C₂, and/or C₄ to C₁₀ alpha-olefin derived unit content in the range of about 5 to 30 weight %; (b) an intermolecular composition distribution of greater than or equal to 75%; (c) a Tm in the range of from about 25° C. to about 110° C.; (d) a Hf in the range of from about 0.5 to about 70 J/g; (e) a Mw/Mn in the range of from about 1.2 to about 4.5; and (f) a MFR in the range of from about 0.1 to about 40 g/10 min; and wherein the multilayer polymeric film has a seal strength greater than 6.25 N/cm, at a dwell time of 0.75 seconds.

In another aspect, the disclosure relates to a method for forming a multilayer polymeric film comprising: (1) forming at least one layer A by extruding a first polymeric resin comprising propylene derived units to form an extrudate, wherein the first polymeric resin has: (i) a propylene derived unit content of greater than 90 weight %, based on the weight of the first polymeric resin; (ii) a Tm of greater than 120° C.; (iii) a MFR in the range of from about 0.1 to about 100 g/10 min; and (2) forming at least one layer B by extruding a second polymeric resin comprising ethylene derived units to form an extrudate, wherein the second polymeric resin has: (i) a density in the range of from about 0.905 to about 0.980 g/cm³; (ii) an ethylene derived unit content of greater than 50 weight %, based on the weight of the second polymeric resin; and wherein at least one of layers A and B further comprises at least one copolymer of propylene derived units and at least one C₂, and C₄ to C₁₀ alpha-olefin derived units, the copolymer having: (a) a C₂, and/or C₄ to C₁₀ alpha-olefin derived unit content in the range of about 5 to about 30 weight %; (b) an intermolecular composition distribution of greater than or equal to 75%; (c) a Tm in the range of from about 25° C. to about 110° C.; (d) a Hf in the range of from about 0.5 to about 70 J/g; (e) a Mw/Mn in the range of from about 1.2 to about 4.5; and (f) a MFR in the range of from about 0.1 to about 40 g/10 min; and wherein each layer is oriented to the same or different extents; and wherein the orientation comprises: (a) inflating each extrudate to form a first bubble; (b) cooling and collapsing the first bubble to form a primary tube; (c) heating the primary tube; (d) inflating the primary tube to form a second bubble, wherein the second bubble at least partially biaxially orients the film; and (e) cooling and collapsing the second bubble; and (3) combining the layers to form the multilayer polymeric film.

In other aspects, the disclosure relates to articles comprising the multilayer polymeric films disclosed herein.

In yet other aspects, the disclosure relates to packaging film comprising the multilayer polymeric films disclosed herein.

### BRIEF DESCRIPTION OF THE FIGURES

FIG. 1 is a flowchart of an exemplary double-bubble extrusion process.

FIG. 2 is a graph of the shrinkage (TD) of Films 1 and 2 compared to Reference Film 1.

FIG. 3 is a graph of the shrinkage (MD) of Films 1 and 2 compared to Reference Film 1.

### DETAILED DESCRIPTION

As used herein, the term “film” applies to fabricated articles, extruded or otherwise, may have a thickness in the range of 0.1 to 250 mil (2.5 to 6350 μm).

As used herein, the term “layer” is used to refer to each of the one or more compositions, which may be the same or different, that are secured to one another by any appropriate means such as by an inherent tendency of the materials to adhere to one another, or by inducing the compositions to adhere as by a heating, radiative, chemical, or some other appropriate process. Layers are not limited to detectable, discrete compositions contacting one another such that a distinct boundary exists between the compositions. Preferably however, the composition used to make one layer of a film will be different (i.e., the weight percent of components, the properties of each component, and/or the identity of the components may differ) from the composition used to make an adjacent layer, when present. A layer includes a finished product having a continuum of compositions throughout its thickness. The films of the present invention are multilayer, that is, comprise two or more layers. A layer may be laminated, by extrusion lamination or other means, to another layer. Films can be fabricated by any mode recognized in the industry, such as film blowing.

For purposes of this invention and the claims thereto, the term “copolymer” means any polymer comprising two or more different monomers, where “different” means differing by at least one atom, such as the number of carbons. For example, ethylene is a different monomer from propylene, because ethylene has two carbon atoms while propylene has three carbon atoms. For the purposes of this invention and the claims thereto, when a polymer is referred to as comprising a monomer, the monomer present in the polymer is the polymerized form of the monomer. Likewise, when catalyst components are described as comprising neutral stable forms of the components, it is well understood by one of ordinary skill in the art, that the active form of the component is the form that reacts with the monomers to produce polymers.

The term “derived units” as used herein, refers to the polymerized form of the monomer from which the polymer was derived. For example, polyethylene comprises ethylene derived units, and a terpolymer of propylene/ethylene/butene comprises propylene derived units, ethylene derived units and butene derived units.

The new notation numbering scheme for the Periodic Table Groups is used herein as set out in CHEMICAL AND ENGINEERING NEWS, 63(5), 27 (1985).

### Films

Multilayer polymeric films having improved mechanical and optical properties and processability are described herein. These films may be used in a variety of applications such as stretch films, shrink films, bags (i.e., shipping sacks, trash bags and liners, industrial liners, and produce bags), flexible and food packaging (e.g., fresh cut produce packaging, frozen food packaging), personal care films, pouches, medical film products, and diaper back sheets. Products may also include packaging, for example by bundling, packaging and unitizing a variety of products. Applications for such packaging include various foodstuffs, rolls of carpet, liquid containers and various like goods normally containerized and/or palletized for shipping, storage, and/or display.

To facilitate discussion of different film structures, the following notation is used herein. Each layer of a film is denoted “A” or “B”, where “A” indicates a film layer formed from any of the polymeric resins comprising propylene derived units, as discussed below, and “B” indicates a film layer formed of any of the polymeric resins comprising ethylene derived units, for example, LLDPE polymers and blends, as discussed below. Films may also include additional layers, such as a layer C, comprising material different from either layer A or layer B. For example, layer C may comprise a substrate, a coating, or another polymeric resin. Where a film has more than one layer A, the layers A may be the same or different. Where a film has more than one layer B, the layers B may be the same or different. Where a film has more than one layer C, the layers C may be the same or different. Finally, the symbols for adjacent layers are separated by a slash (/). Using this notation, a three-layer film having an inner layer of a LLDPE polymer blend disposed between two polypropylene (PP) film layers would be denoted A/B/A. Similarly, a five-layer film of alternating outer/inner layers of PP and LDPE would be denoted A/B/A/B/A. Unless otherwise indicated, the left-to-right or right-to-left order of layers does not matter; e.g., an A/A/B/A film is equivalent to an A/B/A/A film.

“Outer” and “inner,” as used herein in reference to layers, refer to the relative spatial disposition of the layers. For example, for a layer configuration such as C/A/A/B/B/A/C, each layer A is outer to any layer B, and each layer B is inner to layer A. In some embodiments herein, each layer A is spatially disposed outwards relative to a layer B. Also, for a layer configuration such as A/B/B/B/B/A, layer A may be referred to as the “skin” layer, because it is the outermost layer of the film. Similarly, layer B may be referred to as the “core” layer, because the layers B are spatially disposed between two skin layers.

As above, one or more of the layers of the films disclosed herein may comprise polymeric resins. “Polymeric resin,” as used herein, includes any known polymer comprising olefin derived units, and in particular, includes polymers of propylene derived units such as propylene homopolymers, propylene random copolymers, propylene impact copolymers, propylene block copolymers, and polymers of ethylene derived units such as high density polyethylene, linear low density polyethylene, low density polyethylene, and blends thereof.

The thickness of each layer of the film, and of the overall film, is not particularly limited, but is determined according to the desired properties of the film. Typical film layers have a thickness of from about 1 to about 10,000 μm, more typically from about 5 to about 1,000 μm, and typical films have an overall thickness of from about 10 to about 100 μm.

In further applications, microlayer technology may be used to produce films with a large number of thinner layers. For example, microlayer technology may be used to obtain films having, for example, 24, 50, or 100 layers, in which the thickness of an individual layer is less than 1 μm. Individual layer thicknesses for these films may be less than 0.5 μm, less than 0.25 μm, or even less than 0.1 μm.

The multilayer polymeric films can have any number of layers in any ratio of thicknesses. In a preferred embodiment, a three layer film is produced having an outer skin layer, a middle core layer, and an inner skin layer in a ratio within a range of from 1/1/1 to 1/20/1 in one embodiment, and from 1/2/1 to 1/15/1 in another embodiment, and from 1/3/1 to 1/10/1 in yet another embodiment. Each layer can be any desirable thickness, and is within the range of from 1 to 100 μm in one embodiment, and from 2 to 80 μm in another embodiment, and from 2 to 60 μm in yet another embodiment, and from 3 to 40 μm in yet another embodiment, and from 4 to 15 μm in yet another embodiment. Given the variety of film structures as mentioned above (e.g., A/B/A, A/A/B/A/A, etc.), the total film thickness can vary greatly. In one embodiment, the total film thickness or “film thickness” is within the range from 10 to 500 μm, and from 20 to 400 μm in another embodiment, and from 30 to 300 μm in yet another embodiment, and from 40 to 200 μm in yet another embodiment, and from 50 to 150 μm in yet another embodiment. Of course, a desirable thickness range of the layers and film can comprise any combination of an upper limit with any lower limit as described herein.

In embodiments herein, the multilayer polymeric films comprise at least one layer A and at least one layer B, wherein at least one of layers A and B further comprises a copolymer of propylene derived units and one or more C₂, and C₄ to C₁₀ alpha-olefin derived units. In some embodiments, the film comprises a combination of one or more of layers A and B arranged in a layer configuration, for example A/B/A, wherein a film having the ABA structure has three layers, an inner layer B, and outer layers A on either face of B. Examples of other layer configurations include A/A/B/A/A, A/B/A/A, A/B/A/B/A, A/A/B/B/B/A, A/B/B/B/B/A, A/A/B/B/B/A/A, and other variants comprising from 2, 3, 4, 5, 6, 7, 8 or more layers. In particular embodiments, the layer configuration is selected from A/B/B/B/B/A and A/A/B/B/B/A/A.

In other embodiments, the multilayer polymeric film may comprise an additional layer C, where layer C may comprise an adhesion-promoting tie layer, such as PRIMACOR™ ethylene-acrylic acid copolymers available from The Dow Chemical Company (Freeport, Tex.), and/or ethylene-vinyl acetate copolymers. Other materials for C layers can be, for example, foil, nylon, ethylene-vinyl alcohol copolymers, polyvinylidene chloride, polyethylene terephthalate, oriented polypropylene, ethylene-vinyl acetate copolymers, ethylene-acrylic acid copolymers, ethylene-methacrylic acid copolymers, graft modified polymers, and paper. Further, one or more C layers can be replaced with a substrate layer, such as glass, plastic, paper, metal, etc., or the entire film can be coated or laminated onto a substrate. Thus, the inventive multilayer polymeric films disclosed herein can be coated onto a substrate such as paper, metal, glass, plastic and other materials capable of accepting a coating. Such coated structures and articles are also within the scope of the present invention.

More specifically, in embodiments herein, multilayer polymeric films comprise:

at least one layer A, comprising: a first polymeric resin, the first polymeric resin comprising propylene derived units and having: (a) a propylene derived unit content of greater than 90 weight %, based on the weight of the first polymeric resin; (b) a peak melting point (Tm) of greater than 120° C.; and (c) a melt-mass flow rate (MFR) in the range of from about 0.1 to about 100 g/10 min; and at least one layer B, comprising a second polymeric resin, the second polymeric resin comprising ethylene derived units and having: (a) a density in the range of about 0.905 to about 0.945 g/cm³; (b) an ethylene derived unit content of greater than 50 weight %, based on the weight of the second polymeric resin; (c) a composition distribution breadth index (CDBI) of greater than 50%; (d) a melt index (MI) in the range of about 0.1 to about 5.0 g/10 min; and (e) a branching index (g′) of greater than about 0.7; and wherein at least one of layers A and B further comprises at least one copolymer of propylene derived units and one or more C₂, and C₄ to C₁₀ alpha-olefin derived units, the copolymer having: (a) a C₂, and/or C₄ to C₁₀ alpha-olefin derived unit content in the range of about 5 to 25 weight %; (b) an intermolecular composition distribution (ICD) of greater than or equal to 75%; (c) a Tm in the range of from about 25° C. to about 110° C.; (d) a heat of fusion (Hf) in the range of from about 0.5 to about 70 J/g; (e) a molecular weight distribution (Mw/Mn) in the range of from about 1.2 to about 4.5; and (f) a MFR in the range of from about 0.1 to about 40 g/10 min; and
wherein the multilayer polymeric film has a seal strength greater than 6.25 N/cm, at a dwell time of 0.75 seconds.

Each of layer A, layer B, and the copolymer of propylene derived units and one or more C₂, and C₄ to C₁₀ alpha-olefin derived units is described further below.

### Layer A: First Polymeric Resin of Propylene Derived Units

Layer A comprises a first polymeric resin, the first polymeric resin comprising propylene derived units and having: (a) a propylene derived unit content of greater than 90 weight %, greater than 93 weight %, or greater than 95 weight %, based on the weight of the first polymeric resin; (b) a Tm of greater than 120° C., greater than 125° C., or greater than 130° C.; and (c) a MFR in the range of from about 0.1 to about 100 g/10 min, from about 1 to about 50 g/10 min, from about 2 to about 25 g/10 min, or from about 2 to about 15 g/10 min.

The first polymeric resin has a propylene derived unit content of greater than 90 weight %, greater than 93 weight %, or greater than 95 weight %. As used with respect to weight %, “propylene derived unit content” means the weight % of propylene derived units based upon total weight of the first polymeric resin. In some embodiments, the first polymeric resin may be a homopolymer, where the first polymeric resin may comprise only propylene derived units, thereby having a propylene derived unit content of 100 weight %.

The first polymeric resin has a Tm of greater than 120° C., greater than 125° C., or greater than 130° C. The procedure for measuring Tm is described as follows. Tm is measured using Differential Scanning calorimetry (DSC) using commercially available equipment such as a TA Instruments 2920 DSC. Typically, 6 to 10 mg of molded polymer or plasticized polymer is sealed in an aluminum pan and loaded into the instrument at room temperature. Melting data (first heat) is acquired by heating the sample to at least 30° C. above its melting temperature, typically 220° C. for polypropylene, at a heating rate of 10° C./min. The sample is held for at least 5 minutes at this temperature to destroy its thermal history. Crystallization data are acquired by cooling the sample from the melt to at least 50° C. below the crystallization temperature, typically −50° C. for polypropylene, at a cooling rate of 20° C./min. The sample is held at this temperature for at least 5 minutes, and finally heated at 10° C./min to acquire additional melting data (second heat). The endothermic melting transition (first and second heat) and exothermic crystallization transition are analyzed for onset of transition and peak temperature. The melting temperatures reported are the peak melting temperatures from the second heat unless otherwise specified. For polymers displaying multiple peaks, the melting point (or Tm) is defined to be the peak melting temperature (i.e., associated with the largest endothermic calorimetric response in that range of temperatures) from the DSC melting trace; likewise, the crystallization temperature (Tc) is defined to be the peak crystallization temperature (i.e., associated with the largest exothermic calorimetric response in that range of temperatures) from the DSC crystallization trace.

The first polymeric resin has a MFR in the range of from about 0.1 to about 100 g/10 min, from about 1 to about 50 g/10 min, from about 2 to about 25 g/10 min, from about 2 to about 15 g/10 min. MFR is measured by ASTM-1238, 2.16 kg at 230° C., with a 1 minute preheat on the sample to provide a steady temperature for the duration of the experiment.

In embodiments herein, the first polymeric resin may be a homopolymer or copolymer. In particular embodiments, the first polymeric resin comprises a polypropylene/alpha-olefin copolymer, for example, the first polymeric resin may be a propylene-based terpolymer or a propylene-based random copolymer. “Propylene-based,” as used herein means that the polymer comprises greater than 90 weight % propylene derived units. A “terpolymer” is a polymer consisting of three monomers that are different from each other, where “different” means differing by at least one atom, such as the number of carbons. For example, in a particular embodiment, the first polymeric resin is a propylene/ethylene/butene terpolymer comprising propylene, ethylene, and butene monomers. A copolymer is considered a “random copolymer” if the number and distribution of comonomer derived units is consistent with the random statistical polymerization of the monomers. In a particular embodiment, the first polymeric resin is a polypropylene/ethylene random copolymer.

The first polymeric resin may be formed of any resin comprising propylene derived units known in the art for use in multilayer films or in film-coated products. Thus, for example, any of the A layers may be formed of a polypropylene homopolymer or copolymer, and the polypropylene may be, for example, a random propylene copolymer, a propylene-based terpolymer, as well as other polypropylenes known in the art. The polypropylene can be produced by any suitable process, including metallocene-catalyzed processes and Ziegler-Natta catalyzed processes. Further, each A layer can be a blend of two or more such polypropylenes, and can include additives known in the art. For example, the first polymeric resin may comprise a blend of one or more propylene-based polymers. Polymeric resins useful in layer A include those commercially available from ExxonMobil Chemical Company (Houston, Tex.) under the trade designations EXCEED™, EXACT™, ACHIEVE™, EXXTRAL™, EXXPOL™, or ENHANCE™, and those commercially available from LyondellBasell Polymers (The Netherlands) under the trade designations ADSYL or CLYRELL.

### Layer B: Second Polymeric Resin of Ethylene Derived Units

Layer B comprises comprising a second polymeric resin, the second polymeric resin comprising ethylene derived units and having: (a) a density in the range of about 0.905 to about 0.945 g/cm³, from about 0.918 g/cm³ to about 0.930 g/cm³, from about 0.921 g/cm³ to about 0.928 g/cm³, from about 0.918 g/cm³ to about 0.925 g/cm³, from about 0.926 g/cm³ to about 0.928 g/cm³, or from about 0.918 g/cm³ to about 0.922 g/cm³; (b) an ethylene derived unit content of greater than 50 weight %, based on the weight of the second polymeric resin, greater than 60 weight %, greater than 70 weight %, greater than 80 weight %, or greater than 90 weight %; (c) a CDBI of greater than 50%, greater than 60%, or greater than 75%; (d) a MI in the range of about 0.1 to about 5.0 g/10 min, from about 0.1 to about 3.0 g/10 min, from about 0.1 to about 1.0 g/10 min, from about 0.3 to about 1.5 g/10 min, or from about 0.5 to about 1.0 g/10 min; and (e) a g′ of greater than about 0.7, greater than 0.8, or greater than 0.9.

The second polymeric resin has a density in the range of about 0.905 to about 0.945 g/cm³. In a preferred embodiment, the second polymeric resin comprises a linear low density polyethylene (LLDPE). As used herein, the terms “linear low density polyethylene” and “LLDPE” refer to a polyethylene homopolymer or, preferably, copolymer having a density of from about 0.910 g/cm³ to about 0.945 g/cm³.

In other embodiments, the second polymeric resin has a density in the range of from about 0.918 g/cm³ to about 0.930 g/cm³, more preferably from about 0.921 g/cm³ to about 0.928 g/cm³, from about 0.918 g/cm³ to about 0.925 g/cm³, from about 0.926 g/cm³ to about 0.928 g/cm³, or from about 0.918 g/cm³ to about 0.922 g/cm³. In another embodiment, the copolymer has a density of about 0.920 g/cm³, or about 0.927 g/cm³.

The second polymeric resin has an ethylene derived unit content based on the weight of the second resin, of greater than 50 weight %, greater than 60 weight %, greater than 70 weight %, greater than 80 weight %, or greater than 90 weight %. The second polymeric resin may be a homopolymer, where the first polymeric resin may comprise only propylene derived units, thereby having a propylene derived unit content of 100%. Where the second polymeric resin is a copolymer, the second polymeric resin may have a comonomer content of less than 50 weight %, less than 40 weight %, less than 30 weight %, less than 20 weight %, less than 10 weight %. ¹³C nuclear magnetic resonance (NMR) spectroscopy is one of a number of techniques known in the art for measuring comonomer incorporation into a polymer. An example of this technique is described for the determination of comonomer content for ethylene/alpha-olefin copolymers in Randall (Journal of Macromolecular Science, Reviews in Macromolecular Chemistry and Physics, C29 (2 & 3), 201-317 (1989)). The basic procedure for determining the comonomer content of an polyolefin involves obtaining the ¹³C NMR spectrum under conditions where the intensity of the peaks corresponding to the different carbons in the sample is directly proportional to the total number of contributing nuclei in the sample. Methods for ensuring this proportionality are known in the art and involve allowance for sufficient time for relaxation after a pulse, the use of gated-decoupling techniques, relaxation agents, and the like. The relative intensity of a peak or group of peaks is obtained in practice from its computer-generated integral. After obtaining the spectrum and integrating the peaks, those peaks associated with the comonomer are assigned. This assignment can be made by reference to known spectra or literature, or by synthesis and analysis of model compounds, or by the use of isotopically labeled comonomer. The mole % comonomer can be determined by the ratio of the integrals corresponding to the number of moles of comonomer to the integrals corresponding to the number of moles of all of the monomers in the copolymer, as described in Randall, for example. The data is collected using a Varian UNITY Plus 400 MHz NMR spectrometer. Mole % may then be converted to weight %.

In preferred embodiments, the second polymeric resin is a copolymer of ethylene and at least one other alpha-olefin. The comonomers that are useful in general for making the second polymeric resin include alpha-olefins, such as C₃ to C₂₀ alpha-olefins, preferably C₃ to C₁₀ alpha-olefins, and more preferably C₃-C₈ alpha-olefins. The alpha-olefin comonomer may be linear or branched, and two or more comonomers may be used, if desired. Examples of suitable comonomers include propylene, butene, 1-pentene; 1-pentene with one or more methyl, ethyl, or propyl substituents; 1-hexene; 1-hexene with one or more methyl, ethyl, or propyl substituents; 1-heptene; 1-heptene with one or more methyl, ethyl, or propyl substituents; 1-octene; 1-octene with one or more methyl, ethyl, or propyl substituents; 1-nonene; 1-nonene with one or more methyl, ethyl, or propyl substituents; ethyl, methyl, or dimethyl-substituted 1-decene; 1-dodecene; and styrene.

Polymers having more than three types of monomers, such as terpolymers, are also included within the term “copolymer,” as used herein. For example, the combinations of ethylene with a comonomer may include: ethylene/propylene, ethylene/butene, ethylene/1-pentene; ethylene/4-methyl-1-pentene; ethylene/1-hexene; ethylene/1-octene; ethylene/decene; ethylene/dodecene; ethylene/1-hexene/1-pentene; ethylene/1-hexene/4-methyl-1-pentene; ethylene/1-hexene/1-octene; ethylene/1-hexene/decene; ethylene/1-hexene/dodecene; ethylene/1-octene/1-pentene; ethylene/1-octene/4-methyl-1-pentene; ethylene/1-octene/1-hexene; ethylene/1-octene/decene; ethylene/1-octene/dodecene; combinations thereof, and like permutations.

The second polymeric resin has a composition distribution breadth index (CDBI) of greater than 50%, greater than 60%, or greater than 75%. CDBI is defined as the weight percent of the copolymer molecules having a comonomer content within 50% (that is, 25% on each side) of the median total molar comonomer content. CDBI may be determined using techniques for isolating individual fractions of a sample of the polymeric resin. One such technique is Temperature Rising Elution Fraction (TREF), as described in Wild, et al., J. Poly. Sci., Poly. Phys. Ed., vol. 20, p. 441 (1982) and U.S. Pat. No. 5,008,204, where the technique is modified by ignoring the trace below 15,000 g/mol, which is incorporated herein by reference. To determine CDBI, a solubility distribution curve is first generated for the copolymer, using data acquired from the TREF technique described above. The solubility distribution curve, which is a plot of the weight fraction of the copolymer that is solubilized as a function of temperature, is converted to a weight fraction versus composition distribution curve. For the purpose of simplifying the correlation of composition with elution temperature, the weight fractions less than 15,000 g/mol are ignored. These low weight fractions generally represent a trivial portion of the resin of the layer B. The remainder of this description and the appended claims maintains this convention of ignoring weight fractions below 15,000 g/mol in the CDBI measurement. From the weight fraction versus composition distribution curve, the CDBI is determined by establishing what weight percent of the sample has a comonomer content within 25% each side of the median comonomer content.

The second polymeric resin has a melt index (MI) in the range of from about 0.1 to about 5.0 g/10 min, from about 0.1 to about 3.0 g/10 min, from about 0.1 to about 1.0 g/10 min, from about 0.3 to about 1.5 g/10 min, or from about 0.5 to about 1.0 g/10 min. MI is measured according to ASTM D-1238, 190° C., 2.16 kg.

The second polymeric resin has a branching index (g′) of greater than about 0.7, greater than 0.8, or greater than 0.9. The branching index (g′) is calculated using the output of a SEC-DRI-LS-VIS method as follows. A High Temperature Size Exclusion Chromatograph (SEC, either from Waters Corporation or Polymer Laboratories), equipped with a differential refractive index detector (DRI), an online light scattering (LS) detector, and a viscometer (VIS) is used. In particular, a high temperature Viscotek Corporation viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the following equation:

ηₛ=c[η]+0.3(c[η])²

where c is concentration and is determined from the DRI output. The average intrinsic viscosity, [η]_{avg}, of the sample is calculated by:

$${[ η ]}_{avg} = \frac{\sum {{c}_{i} [ η ]}_{i}}{\sum {c}_{i}}$$

where the summations are over the chromotographic slices, i.e., between the integration limits. The branching index g′ is defined as:

$${g}^{′} = \frac{{[ η ]}_{avg}}{{kM}_{v}^{α}}$$

where, for purpose of this invention and claims thereto, α=0.695 for ethylene, propylene, and butene polymers; and k=0.000579 for ethylene polymers, k=0.000262 for propylene polymers, and k=0.000181 for butene polymers. Mᵥ is the viscosity-average molecular weight based on molecular weights determined by SEC-DRI-LS-VIS analysis. It is well known in the art that as the g′ value decreases, long-chain branching increases.

In particular embodiments, the second polymeric resin comprising ethylene derived units has one or more of the following additional properties: (a) a melt strength (MS) of greater than about 2.0 cN, or greater than about 4.0 cN; (b) a relation between MI (in g/10 min) and MS (in cN) according to the formula: MS=−2.6204*MI+7.5686; and (c) a Melt Index Ratio (MIR) in the range of from about 25 to about 80, or from about 30 to about 55, or from about 35 to about 45, more particularly, from about 38 to about 42, or from about 32 to about 38.

In some embodiments, the second polymeric resin has a MS of greater than about 2.0 cN, or greater than about 4.0 cN. MS or extensional viscosity is determined using the Rheotens 71-97 in combination with the Rheograph 2002 as described: (1) Rheograph 2002 has: temperatures of 190° and 230° C., die: 30/2, piston speed: 0.178 mm/s, shear rate: 40.050 s⁻¹, wheels: grooved, (2) Strand: length: 100 mm, V₀: 10 mm/s, and (3) Rheotens: gap: 0.7 mm, acceleration: 12.0 mm/s². For each material, several measurements are performed, and a mean curve plotted. The numerical data of this mean curve is reported as MS.

In another embodiment, second polymeric resin has a MIR, I_{21.6}/I_{2.16}, of from about 30 to about 55. More preferably, the MIR is from about 30 to about 50, or from about 35 to about 45. In some embodiments, the copolymers have a MIR of from about 38 to about 42, or from about 32 to about 38. MIR is the ratio of high load MI to low load MI (I_{21.6}(190° C., 21.6 kg)/I_{2.16}(190° C., 2.16 kg), and is described in ASTM D-1238.

In some embodiments, the second polymeric resin may comprise a blend of one or more polymers. The second polymeric resin may be combined with at least one additional polymer that is a high density polyethylene (HDE), a very low density polyethylene (VLDPE), a linear low density polyethylene (LLDPE), a low density polyethylene (LDPE), a medium density polyethylene (MDPE), a differentiated polyethylene, or combinations thereof. In a particular embodiment, the second resin is a single grade, and is not blended with another polymer.

In embodiments herein, the second polymeric resin is made using a metallocene catalyst. For example, the second polymeric resin may be obtained via using a supported catalyst comprising an activated metallocene in the substantial absence of an aluminum alkyl based scavenger (e.g., triethylaluminum (TEAL), trimethylaluminum (TMAL), triisobutyl aluminum (TIBAL), tri-n-hexylaluminum (TNHAL), and the like. As used herein, the term “metallocene catalyst” is defined to comprise at least one transition metal compound containing one or more substituted or unsubstituted cyclopentadienyl moieties (Cp) (typically two Cp moieties) in combination with a Group 4, 5, or 6 transition metal (M).

Metallocene catalysts generally require activation with a suitable co-catalyst, or activator, in order to yield an “activated metallocene catalyst”, i.e., an organometallic complex with a vacant coordination site that can coordinate, insert, and polymerize olefins. Activated catalyst systems generally include not only the metallocene complex, but also an activator, such as an alumoxane or a derivative thereof (preferably methyl alumoxane), an ionizing activator, a Lewis acid, or a combination thereof. Alkylalumoxanes (typically methyl alumoxane and modified methylalumoxanes) are particularly suitable as catalyst activators. The catalyst system may be supported on a carrier, typically an inorganic oxide or chloride, or a resinous material such as, for example, polyethylene or silica.

Useful metallocene compounds include bridged and unbridged biscyclopentadienyl zirconium compounds (particular where the Cp rings are indenyl or fluorenyl groups). Non-limiting examples of metallocene catalysts and catalyst systems useful in practicing the present invention include those described in, inter alia, International Publication Nos. WO 96/11961 and WO 96/11960, and in U.S. Pat. Nos. 4,808,561; 5,017,714; 5,055,438; 5,064,802; 5,124,418; 5,153,157; and 5,324,800. More recent examples include the catalysts and systems described in U.S. Pat. Nos. 6,380,122 and 6,376,410; International Publication No. WO 01/98409, and in the references cited therein, all of which are fully incorporated herein by reference.

As to the process conditions, the overall conditions described in U.S. Pat. No. 5,763,543, incorporated herein by reference, may be adopted. It is believed that a combination of particular process conditions is beneficial in making the second polymeric resin, described herein. In particular, it is advantageous to use a catalyst system in which the metallocene has a pair of bridged cyclopentadienyl groups, preferably with the bridge consisting of a single carbon, germanium or silicon atom so as to provide an open site on the catalytically active cation. The activator may be methyl alumoxane as described in U.S. Pat. Nos. 5,324,800; 5,580,939; and 5,633,394, all of which are incorporated herein by reference, or a non-coordinated anion as described in U.S. patent application Ser. No. 08/133,480, incorporated herein by reference. Additionally, as above, there should be substantially no scavengers which may interfere with the reaction between the vinyl end unsaturation of polymers formed and the open active site on the cation. By the statement “substantially no scavengers” and “substantially devoid or free of Lewis acid scavengers,” it is meant that there should be less than 100 ppm by weight of such scavengers present in the feed gas, or preferably, no intentionally added scavenger, such as, for example, an aluminum alkyl scavenger, other than that which may be present on the support.

The preferred conditions for the production of the second resin of the invention also include steady state polymerization conditions which are not likely to be provided by batch reactions in which the amount of catalyst poisons can vary and where the concentration of the comonomer may vary in the production of the batch. The overall continuous gas phase processes for the formation of the second resin used herein may therefore comprise: (1) continuously circulating a feed gas stream containing monomer and inerts to thereby fluidize and agitate a bed of polymer particles, (2) adding metallocene catalyst to the bed, and (3) removing polymer particles, in which: a) the catalyst comprises at least one bridged bis cyclopentadienyl transition metal and an alumoxane activator on a common or separate porous support; b) the feed gas is substantially devoid of a Lewis acidic scavenger and wherein any Lewis acidic scavenger is preferably present in an amount less than 100 ppm by weight of the feed gas; c) the temperature in the bed is no more than 20° C. less than the polymer melting temperature as determined by DSC, at a ethylene partial pressure in excess of 60 pounds per square inch absolute (414 kPa); and d) the removed polymer particles have an ash content of transition metal of less than 500 ppm by weight, an MI less than 10, an MIR at least 35, and substantially no detectable chain end unsaturation as determined by ¹H NMR.

By the statement that the polymer has “substantially no detectable end chain unsaturation,” it is meant that the polymer has vinyl unsaturation of less than 0.1 vinyl groups per 1000 carbon atoms in the polymer, preferably less than 0.05 vinyl groups per 1000 carbon atoms, and more preferably 0.01 vinyl groups per 1000 carbon atoms or less, as measured by ¹H NMR.

The processes described above aim to provide the second resin via the use of a single catalyst, and the processes do not depend on the interaction of bridged and unbridged species. Preferably, the catalyst is substantially devoid of a metallocene having a pair of π-bonded ligands (e.g., cyclopentadienyl compounds) which are not connected through a covalent bridge. In other words, no such unbridged metallocene is intentionally added to the catalyst or, preferably, no such unbridged metallocene can be identified in such catalyst. Additionally, the processes use substantially a single metallocene species comprising a pair of π-bonded ligands, at least one of which has a structure with at least two cyclic fused rings (e.g., indenyl rings). Best results may be obtained by using a substantially single metallocene species comprising a monoatom silicon bridge connecting two polynuclear π-bonded ligands to the transition metal atom.

The catalyst is preferably supported on silica with the catalyst homogeneously distributed in the silica pores. Preferably, fairly small amounts of methyl alumoxane should be used, such as amounts giving an Al to transition metal ratio in the range of from 400 to 30, and especially from 200 to 50.

Additionally, the use of a process continuity aid, while not required, may be desirable in any of the foregoing processes. Such continuity aids are well known to persons of skill in the art and include, for example, metal stearates, such as calcium stearate.

Polymeric resins comprising ethylene derived units that are useful in layer B of the multilayer films described herein include those commercially available from ExxonMobil Chemical Company (Houston, Tex.), such as those sold under the trade designation ENABLE™. Particularly useful polymeric resins include ENABLE™ 20-05, ENABLE™ 20-05CH, and ENABLE™ 27-05CH.

### Copolymer of Propylene Derived Units and C₂ and C₄ to C₁₀ Alpha-Olefin Derived Units

At least one of layers A and B further comprises at least one copolymer of propylene derived units and one or more C₂, and C₄ to C₁₀ alpha-olefin derived units, the copolymer having: (a) a C₂, and/or C₄ to C₁₀ alpha-olefin derived unit content in the range of about 5 to 30 weight %, preferably from about 5 to 25 weight %, more preferably from about 8 to about 25 weight %, even more preferably 8 to 15 weight %; (b) an ICD of greater than or equal to 75%, greater than 80%, greater than 85%, preferably greater than 90%; (c) a Tm in the range of from about 25° C. to about 110° C., preferably from about 25° C. to about 85° C., from 25° C. to about 75° C., about 25° C. to about 65° C., about 30° C. to about 75° C., more preferably about 30° C. to about 60° C.; (d) a Hf in the range of from about 0.5 to about 70 J/g, preferably from about 0.5 to about 50 J/g, or more preferably from about 5 to about 40 J/g; (e) a Mw/Mn in the range of from about 1.2 to about 4.5; and (f) a MFR in the range of from about 0.1 to about 40 g/10 min, preferably from about 1 to about 20 g/10 min, more preferably from about 2 to about 5 g/10 min.

The copolymer of propylene derived units and one or more C₂, and C₄ to C₁₀ alpha-olefin derived units has an average C₂, and/or C₄ to C₁₀ alpha-olefin derived unit content, based on the weight of the copolymer, in the range of from about 5 to 30 weight %, preferably from about 5 to 25 weight %, more preferably from about 8 to about 25 weight %, even more preferably 8 to 15 weight %. The balance of the propylene copolymer may be one or more C₂, and C₄ to C₁₀ alpha-olefin derived units, as specified above. Accordingly, copolymers of propylene derived units and one or more C₂, and C₄ to C₁₀ alpha-olefin derived units useful in the present invention have an average propylene content, based on the weight of the copolymer, of from about 70 to about 95 weight %, more preferably from about 75 to about 95 weight %, more preferably from about 75 to about 92 weight %, most preferably from about 85 to about 92 weight %.

The copolymer of propylene derived units and one or more C₂, and C₄ to C₁₀ alpha-olefin derived units has an ICD of greater than 75%, greater than 80%, greater than 85%, preferably greater than 90%. ICD is an indicator of intermolecular homogeneity. The intermolecular composition distribution of the copolymer is determined by thermal fractionation in a solvent. A typical solvent is a saturated hydrocarbon such as hexane or heptane. The thermal fractionation procedure is described below. ICD may be determined by weight of the polymer isolated as one or two adjacent, soluble fractions with the balance of the polymer in immediately preceding or succeeding fractions; and wherein each of these fractions has a weight % comonomer content with a difference of no greater than 20 weight % (relative), preferably 10 weight % (relative), of the average weight % comonomer of the copolymer. The fractions are obtained at temperature increases of approximately 8° C. between stages. The ICD of the copolymer is determined by thermal fractionation in hexane as follows: about 30 grams of the semi-amorphous polymer is cut into small cubes of about ⅛ inch (0.32 cm) on the side and is then introduced into a thick walled glass bottle closed with screw cap along with 50 mg of Irganox 1076, an antioxidant commercially available from Ciba Specialty Chemicals (Basel, Switzerland). Then, 425 ml of hexane (a principal mixture of normal and iso isomers) is added to the contents of the bottle and the sealed bottle is maintained at about 23° C. for 24 hours. At the end of this period, the solution is decanted and the residue is treated with additional hexane for an additional 24 hours at 23° C. At the end of this period, the two hexane solutions are combined and evaporated to yield a residue of the polymer soluble at 23° C. To the residue is added sufficient hexane to bring the volume to 425 ml and the bottle is maintained at about 31° C. for 24 hours in a covered circulating water bath. The soluble polymer is decanted and the additional amount of hexane is added for another 24 hours at about 31° C. prior to decanting. In this manner, fractions of the semi-amorphous polymer soluble at 40° C., 48° C., 55° C., and 62° C. are obtained at temperature increases of approximately 8° C. between stages. The soluble polymers are dried, weighed and analyzed for composition, as weight % ethylene content. To produce a copolymer having the desired narrow intermolecular composition distribution, it is beneficial if (1) a metallocene catalyst is used, preferably one which behaves as though only a single statistical mode of addition of the first and second monomer sequences is allowed and (2) the copolymer is well-mixed in a continuous flow stirred tank polymerization reactor which allows only a single polymerization environment for substantially all of the polymer chains of the copolymer.

The copolymer of propylene derived units and one or more C₂, and C₄ to C₁₀ alpha-olefin derived units has a Tm in the range of from about 25° C. to about 110° C., preferably from about 25° C. to about 85° C., from 25° C. to about 75° C., about 25° C. to about 65° C., about 30° C. to about 75° C., more preferably about 30° C. to about 60° C. Tm is measured using the DSC procedure discussed above.

The copolymer of propylene derived units and one or more C₂, and C₄ to C₁₀ alpha-olefin derived units has a Hf in the range of from about 0.5 to about 70 J/g, preferably from about 0.5 to about 50 J/g, or more preferably from about 5 to about 40 J/g. Preferably copolymers of propylene derived units and one or more C₂, and C₄ to C₁₀ alpha-olefin derived units also have a heat of fusion that is greater than or equal to about 1 J/g, preferably greater than or equal to about 2.5 J/g, preferably greater than or equal to about 5 J/g. Hf is determined according to the procedure described in ASTM E794-06, using a differential scanning calorimeter (DSC), as described below. Areas under the DSC curve are used to determine the heat of transition (Hf, upon melting or heat of crystallization, Hc, upon crystallization, if the Hf value from the melting is different from the Hf value obtained for the heat of crystallization, then the value from the melting (Tm) shall be used).

The copolymer of propylene derived units and one or more C₂, and C₄ to C₁₀ alpha-olefin derived units has a Mw/Mn in the range of from about 1.2 to about 4.5. Techniques for determining the molecular weight (Mn, number average molecular weight, and Mw, weight average molecular weight) and molecular weight distribution (Mn/Mw) may be found in U.S. Pat. No. 4,540,753, which is incorporated by reference herein, and in Macromolecules 1988, 21, 3360, which is also incorporated by reference herein. Mw and Mn may be determined by size exclusion chromatography (SEC), e.g., 3D SEC, also referred to as GPC-3D. The Mn/Mw, also known as the polydispersity index, is the ratio of Mw to Mn.

The copolymer of propylene derived units and one or more C₂, and C₄ to C₁₀ alpha-olefin derived units has a MFR in the range of from about 0.1 to about 40 g/10 min, preferably from about 1 to about 20 g/10 min, more preferably from about 2 to about 5 g/10 min. As above, MFR is measured by ASTM D-1238, at 230° C., at 2.16 kg.

In a preferred embodiment, the copolymer of propylene derived units and one or more C₂, and C₄ to C₁₀ alpha-olefin derived units may have a g′ of about 0.99 or greater. The g′ is determined as previously described. As above, it is well known in the art that as the g′ value decreases, long-chain branching increases.

The copolymer of propylene derived units and one or more C₂, and C₄ to C₁₀ alpha-olefin derived units may be characterized by other properties such as Tc, density, percent crystallinity, a substantial absence of ¹³C NMR peaks corresponding to a regio-error at about 14.6 and about 15.7 ppm, the peaks being of about equal intensity, an mm triad tacticity index, propylene tacticity index m/r, and Mooney viscosity, as described below.

In particular embodiments, the copolymer of propylene derived units and one or more C₂, and C₄ to C₁₀ alpha-olefin derived units may have any of (i) a Tc of about 200° C. or less, more preferably, 150° C. or less; (ii) a density in the range of from about 0.85 to about 0.92 g/cm³, more preferably, from about 0.87 to 0.90 g/cm³, more preferably from about 0.88 to about 0.89 g/cm³; (iii) percent crystallinity in the range of from 0.25% to 40%, preferably from about 0.25% to about 25%, more preferably from about 0.5% to about 22%, and most preferably from about 0.5% to about 20%; (iv) an mm triad tacticity index of 75% or greater, 80% or greater, 82% or greater, 85% or greater, or 90% or greater; (v) a substantial absence of ¹³C NMR peaks corresponding to a regio-error at about 14.6 and about 15.7 ppm, the peaks being of about equal intensity; (vi) a m/r of more than 1; and (vii) a Mooney viscosity of less than 100, more preferably less than 75, even more preferably less than 60, most preferably less than 30.

The copolymer of propylene derived units and one or more C₂, and C₄ to C₁₀ alpha-olefin derived units may have a Tc of about 200° C. or less, more preferably, 150° C. or less. Tc is measured using the DSC methods discussed above.

The copolymer of propylene derived units and one or more C₂, and C₄ to C₁₀ alpha-olefin derived units may have a density in the range from of about 0.85 to about 0.92 g/cm³, more preferably from about 0.87 to 0.90 g/cm³, more preferably from about 0.88 to about 0.89 g/cm³, at room temperature, as measured by the ASTM D-1505 test method.

The copolymer of propylene derived units and one or more C₂, and C₄ to C₁₀ alpha-olefin derived units may have a percent crystallinity in the range of from 0.25% to 40%, preferably from about 0.25% to about 25%, more preferably from about 0.5% to about 22%, and most preferably from about 0.5% to about 20%, wherein percent crystallinity is determined using the DSC procedure described above. Areas under the DSC curve are used to determine the heat of transition (Hf, upon melting or heat of crystallization, Hc, upon crystallization, if the Hf value from the melting is different from the Hf value obtained for the heat of crystallization, then the value from the melting (Tm) shall be used), which can be used to calculate the degree of crystallinity (also called the percent crystallinity). The percent crystallinity (X %) is calculated using the formula: [area under the curve (in J/g)/H° (in J/g)]*100, where H° is the heat of fusion for the homopolymer of the major monomer component. These values for H° are to be obtained from the Polymer Handbook, Fourth Edition, published by John Wiley and Sons, New York 1999, except that a value of 290 J/g is used as the equilibrium heat of fusion)(H° for 100% crystalline polyethylene, a value of 140 J/g is used as the equilibrium heat of fusion)(H° for 100% crystalline polybutene, and a value of 207 J/g)(H° is used as the heat of fusion for a 100% crystalline polypropylene.

The copolymer of propylene derived units and one or more C₂, and C₄ to C₁₀ alpha-olefin derived units has a substantial absence of ¹³C NMR peaks corresponding to a regio-error at about 14.6 and about 15.7 ppm, the peaks being of about equal intensity. The ¹³C NMR peaks corresponding to a regio-error at about 14.6 and about 15.7 ppm are believed to be the result of stereoselective 2,1-insertion errors of propylene units into the growing polymer chain. In typical propylene-ethylene copolymers produced by constrained geometry non-metallocene catalysts, these peaks are of about equal intensity, and they represent about 0.02 to about 7 mole percent of the propylene insertions into the homopolymer or copolymer chain. The copolymer of propylene derived units and one or more C₂, and C₄ to C₁₀ alpha-olefin derived units do not have ¹³C NMR peaks corresponding to a regio-error at about 14.6 and about 15.7 ppm, and is made using a metallocene catalyst.

The copolymer of propylene derived units and one or more C₂, and C₄ to C₁₀ alpha-olefin derived units also has an mm triad tacticity index of three propylene units, as measured by ¹³C NMR techniques described above, of 75% or greater, 80% or greater, 82% or greater, 85% or greater, or 90% or greater. Polymer microstructure discussed herein is determined by ¹³C-NMR spectroscopy, including the concentration of isotactic and syndiotactic diads ([m] and [r]), triads ([mm] and [rr]), and pentads ([mmmm] and [rrrr]). Samples are dissolved in d₂-1,1,2,2-tetrachloroethane. Spectra are recorded at 125° C. using a NMR spectrometer of 100 MHz. Polymer resonance peaks are referenced to [mmmm]=21.8 ppm. Calculations involved in the characterization of polymers by NMR follow the work of F. A. Bovey in “Polymer Conformation and Configuration,” Academic Press, New York 1969 and J. Randall in “Polymer Sequence Determination, ¹³C NMR Method,” Academic Press, New York, 1977. The percent of methylene sequences of two in length, % (CH₂)₂, is calculated as follows: the integral of the methyl carbons between 14-18 ppm (which are equivalent in concentration to the number of methylenes in sequences of two in length) divided by the sum of the integral of the methylene sequences of one in length between 45-49 ppm and the integral of the methyl carbons between 14-18 ppm, times 100. This is a minimum calculation for the amount of methylene groups contained in a sequence of two or more since methylene sequences of greater than two have been excluded. Assignments are based on H. N. Cheng and J. A. Ewen, Makromol. Chem. 1989, 190, 1931. The mm triad tacticity index of a polymer is the relative tacticity of a sequence of three adjacent propylene units, a chain consisting of head to tail bonds, expressed as a binary combination of m and r sequences. It is usually expressed for copolymers of the present invention as the ratio of the number of units of the specified tacticity to all of the propylene triads in the copolymer. The mm triad tacticity index (mm fraction) of a propylene copolymer can be determined from a ¹³C NMR spectrum of the propylene copolymer and the following formula:

$$mm Fraction = \frac{PPP ( mm )}{PPP ( mm ) + PPP ( mr ) + PPP ( rr )}$$

where PPP(mm), PPP(mr) and PPP(rr) denote peak areas derived from the methyl groups of the second units in the following three propylene unit chains consisting of head-to-tail bonds:

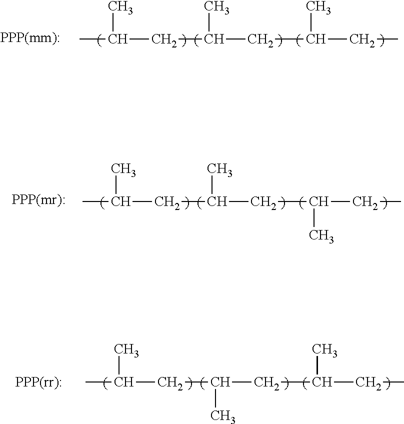

The ¹³C NMR spectrum of the propylene copolymer is measured as described in U.S. Pat. No. 5,504,172 and U.S. Pat. No. 6,642,316 (column 6, line 38 to column 9, line 18). The spectrum relating to the methyl carbon region (19-23 parts per million (ppm)) can be divided into a first region (21.2-21.9 ppm), a second region (20.3-21.0 ppm) and a third region (19.5-20.3 ppm). Each peak in the spectrum was assigned with reference to an article in the journal Polymer, vol. 30 (1989), p. 1350 or an article in the journal Macromolecules, 17, (1984), 1950 (in the event of a conflict between the Polymer article and the Macromolecules article, the Polymer article shall control). In the first region, the methyl group of the second unit in the three propylene derived unit chain represented by PPP (mm) resonates. In the second region, the methyl group of the second unit in the three propylene derived unit chain represented by PPP (mr) resonates, and the methyl group (PPE-methyl group) of a propylene derived unit whose adjacent units are a propylene derived unit and an ethylene derived unit, resonates (in the vicinity of 20.7 ppm). In the third region, the methyl group of the second unit in the three propylene derived unit chain represented by PPP (a) resonates, and the methyl group (EPE-methyl group) of a propylene derived unit whose adjacent units are ethylene units resonates (in the vicinity of 19.8 ppm). The calculation of the mm triad tacticity index is outlined in the techniques shown in U.S. Pat. No. 5,504,172. Subtraction of the peak areas for the error in propylene insertions (both 2,1 and 1,3) from peak areas from the total peak areas of the second region and the third region, the peak areas based on the 3 propylene units-chains (PPP(mr) and PPP(rr)) consisting of head-to-tail bonds, can be obtained. Thus, the peak areas of PPP(mm), PPP(mr) and PPP(rr) can be evaluated, and the mm triad tacticity index of the propylene unit chain consisting of head-to-tail bonds can be determined. Further information on how the mm triad tacticity can be determined from a ¹³C-NMR spectrum of the polymer, is described by J. A. Ewen, “Catalytic Polymerization of Olefins”, (the Ewen method), Eds. T. Keii, K. Soga, Kodanska Elsevier Pub., Tokyo, 1986, p. 271; and as described in detail in U.S. Pat. No. 6,884,850, on page 8, in numbered paragraphs [0046] to [0054], all of which are incorporated by reference herein.

The copolymer of propylene derived units and one or more C₂, and C₄ to C₁₀ alpha-olefin derived units may have a propylene tacticity index, expressed as ratio of m to r (m/r), of more than 1. The propylene tacticity index m/r is determined by ¹³C NMR techniques, as described above. The propylene tacticity index m/r is calculated as discussed in H. N. Cheng, Macromolecules, 17, 1950 (1984). The designation “m” or “r” describes the stereochemistry of pairs of contiguous propylene groups, “m” referring to meso and “r” to racemic. An m/r ratio of 0 to less than 1.0 generally describes a syndiotactic polymer, and an m/r ratio of 1.0 describes an atactic material, and an m/r ratio of greater than 1.0 describes an isotactic material. An isotactic material theoretically may have a ratio approaching infinity, and many by-product atactic polymers have sufficient isotactic content to result in ratios of greater than 50. The copolymer of propylene derived units and one or more C₂, and C₄ to C₁₀ alpha-olefin derived units may have isotactic stereoregular propylene crystallinity. The term “stereoregular,” as used herein, means that the predominant number, i.e., greater than 80%, of the propylene derived units in the polypropylene, exclusive of any other monomer such as ethylene, has the same 1,2 insertion and the stereochemical orientation of the pendant methyl groups is the same, either meso or racemic.

The copolymer of propylene derived units and one or more C₂, and C₄ to C₁₀ alpha-olefin derived units may have a Mooney viscosity ML (1+4)@125° C., as determined according to ASTM D1646, of less than 100, more preferably less than 75, even more preferably less than 60, most preferably less than 30.

In embodiments herein, the copolymer of propylene derived units and one or more C₂, and C₄ to C₁₀ alpha-olefin derived units is made using a metallocene catalyst. Copolymers of propylene derived units and one or more C₂, and C₄ to C₁₀ alpha-olefin derived units used in the present invention are described in detail as the “Second Polymer Component (SPC)” in U.S. Pat. No. 6,500,563 which is fully incorporated by reference herein. The copolymers of propylene derived units and one or more C₂, and C₄ to C₁₀ alpha-olefin derived units may include copolymers prepared according to the procedures in International Publication Nos. WO 02/36651 and WO 00/01745; U.S. Pat. No. 6,992,158. Preferred methods for producing the copolymers are found in U.S. Pat. No. 6,881,800. Preferred copolymers are available commercially under the trade name Vistamaxx™ (ExxonMobil, Baytown Tex.). Suitable examples include: Vistamaxx™ 6202, Vistamaxx™ 3980 FL, Vistamaxx™ 3020 FL, Vistamaxx™ 6102, and Vistamaxx™ 3000.

### Additives

The polymeric resins described herein, in layers A and/or layers B may comprise one or more additives. Additives include, for example, antioxidants, antistatic agents, ultraviolet light absorbers, plasticizers, pigments, dyes, antimicrobial agents, anti-blocking agents (such as anti-block MB), stabilizers, lubricants (e.g., slip agents such as slip MB), processing aids, and the like. The polymeric resins may comprise additives in the range of from about 1 to about 10 weight percent, based on the total weight of the polymeric resin.

### Film Formation

To make the multilayer films disclosed herein, any process that is known in the art can be used such as film-blowing, tenter processes, and casting. The multilayer films may also be used in extrusion coating and thermoforming. In particular embodiments, there the multilayer films disclosed herein may be made by conventional fabrication techniques, for example simple bubble extrusion, biaxial orientation processes (such as tenter frames or double bubble processes), simple cast/sheet extrusion, coextrusion, lamination, etc. Conventional simple bubble extrusion processes (also known as hot blown film processes) are described, for example, in The Encyclopedia of Chemical Technology, Kirk-Othmer, Third Edition, John Wiley & Sons, New York, 1981, vol. 16, pp. 416-417 and vol. 18, pp. 191-192, the disclosures of which are incorporated herein by reference. Biaxial orientation film manufacturing processes such as described in the “double bubble” process of U.S. Pat. No. 3,456,044 (Pahlke), and the processes described in U.S. Pat. No. 4,352,849 (Mueller), U.S. Pat. Nos. 4,820,557 and 4,837,084 (both to Warren), U.S. Pat. No. 4,865,902 (Golike et al.), U.S. Pat. No. 4,927,708 (Herran et al.), U.S. Pat. No. 4,952,451 (Mueller), and U.S. Pat. Nos. 4,963,419 and 5,059,481 (both to Lustig et al.), the disclosures of which are incorporated herein by reference, can also be used to make the novel film structures of this invention.

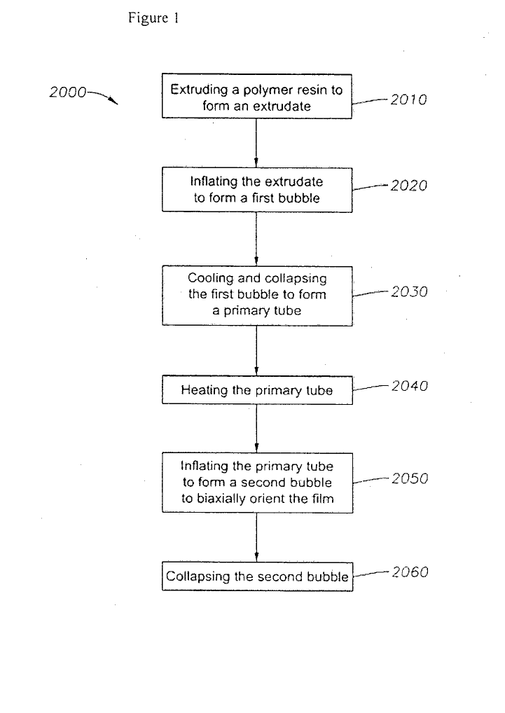

In a preferred embodiment, the multilayer films are blown films. Any coextrusion blown film equipment known in the art can be used. In particular embodiments, the double-bubble process disclosed above is used. As illustrated in FIG. 1, double-bubble extrusion process 2000 comprises: extruding or coextruding a polymer polymeric resin to form an extrudate (Step 2010); inflating or expanding the extrudate to form a first bubble (Step 2020); collapsing the first bubble to form primary tube (Step 2030); heating the primary tube to make it soft (Step 2040); inflating or expanding the primary tube to form a second bubble to biaxially orient the film (Step 2050); and collapsing the second bubble (Step 2060).

Regarding Step 2010, the polymeric resin may comprise a resin comprising ethylene derived units alone, a resin comprising propylene derived units alone, a mixture of a resin comprising propylene derived units and at least one copolymer of propylene derived units and ethylene derived units alone, or in combination with one or more additional polymeric resins as described above. The polymeric resins, copolymers of propylene derived units and ethylene derived units, and/or additional components of the compositions described herein can be fed into the extruders by any means known in the art, such as by a gravimetric feeding system. Each extruder can be equipped with one, two, three, four, five or more feeding hoppers, depending upon the compositions. The blending for each extruder takes place in the special mixing hopper mounted below the feeding hoppers, from where the blend is discharged into the extruder. Each extruder is connected to the die via a screen changer and an adapter. The melt flows are shaped in the die through an annular gap.

The polymer polymeric resin can be extruded using any technique known in the art. The resin comprising ethylene derived units, resin comprising propylene derived units, copolymer of propylene derived units and ethylene derived units, and/or any additional polymeric components may be blended and extruded or may be separately extruded and then joined for coextrusion. The multilayer polymeric films may have three or more layers. In one embodiment, each layer is extruded separately, then combined to form one film structure. In a particular embodiment, three layers of polymeric resin are extruded, and then combined to form a three layer film. In other embodiments, the layers are coextruded, and a collapsed bubble forms the final film in which one layer, an “outer layer” and another layer, an “inner layer”, are combined into a thick new layer. The polymeric resin making up the outer skin layer of the blown film bubble preferably constitutes both outer layers of the final film.

In the double bubble process, the extruder speed, output, and other process variables, such as melt pressure in extruder, set point of the extruder die, and die temperature, can vary for each layer that is extruded to make a film. In one aspect, extruder speeds for making films described herein can be within the range of from 10 to 100 rpm, and from 10 to 50 rpm in one embodiment, and from 15 to 40 rpm in another embodiment, and from 18 to 35 rpm in a particular embodiment, and from 25 to 50 rpm in yet another embodiment, and from 40 to 70 rpm in yet another embodiment, and from 50 to 100 rpm in yet another embodiment. The extruder output can be within the range from 10 to 100 kg/h in one embodiment, and from 10 to 50 kg/h in another embodiment, and from 15 to 40 kg/h in another embodiment, and from 15 to 35 kg/h in yet another embodiment, and from 40 to 80 kg/h in yet another embodiment. The melt pressure in the extruder can be within the range from 150 (15 MPa) to 300 bar (30 MPa) in one embodiment, and from 155 (15.5 MPa) to 260 bar (26 MPa) in another embodiment.

In an embodiment, the polymeric resin is preheated and/or heated within the extruder to a temperature suitable to cause the polymer to soften or melt (e.g., 120 to 230° C.). The heat may be provided using any known technique or equipment. The extruder may have a constant temperature or may have a temperature gradient. The set point temperature of the extruder die can be within the range of from 150 to 280° C. in one embodiment, and from about 160 to 250° C. in another embodiment, and from about 165 to 220° C. in yet another embodiment. Finally, the die temperature can range from about 140 to 220° C. in one embodiment, and from about 150 to 200° C. in another embodiment.

Table 1A below illustrates an exemplary core layer extrusion temperature profile having heat zones 1-5, where the heat zones are evenly spaced along the length of the extruder with Zone 1 closest to the polymeric resin feed and Zone 5 closest to the die. Table 1B illustrates two skin layer extrusion temperature profiles having heat zones 1-4, where the heat zones are evenly spaced along the length of the extruder with Zone 1 closest to the polymeric resin feed and Zone 4 closest to the die.

TABLE 1A
Core Layer Extrusion Temperature Profile

| Zone | 1 | 2 | 3 | 4 | 5 |
|---|---|---|---|---|---|
| Temp. (° C.) | 165 | 175 | 165 | 160 | 155 |

TABLE 1B
Skin Layer Extrusion Temperature Profile

| | | | | |
|---|---|---|---|---|
| Zone | 1 | 2 | 3 | 4 |

Skin Layer Extrusion Temperature Profile 1

| | | | | |
|---|---|---|---|---|
| Temp. (° C.) | 165 | 180 | 165 | 165 |

Skin Layer Extrusion Temperature Profile 2

| | | | | |
|---|---|---|---|---|
| Temp. (° C.) | 165 | 175 | 165 | 165 |

Preferably, the coextrusion blown film line has two, three or more (depending on the desired number of layers) extruders to melt, homogenize and pump the compositions making each layer of film. Any one of the extruders can have any set of desirable dimensions, independent of one another. Further, any one of the extruders can have a smooth feed zone or grooved feed zone.

In operation, the extruder has an extrusion screw that rotates within the extruder to force the molten polymer through a die to form an extrudate having a fixed cross sectional profile (e.g., tubular). In an embodiment, the die is annular, with die gap 0.5 to 3.0 mm. However, it will be understood that dies of various configurations may be used. In an embodiment, the die is operable to maintain a temperature of about 150 to about 200° C., or about 160 to about 190° C.

Regarding Step 2020, after leaving the die, the extrudate may be drawn and blown as a first bubble using any suitable technique or equipment. For example, air may be injected through the die orifice in sufficient quantity to cause the polymeric resin to expand into a bubble of a desired diameter. The film thickness is controlled by Blow Up Ratio (BUR), take-off speed and output. The BUR for blown films can be within a range of from 1 to 10 in one embodiment, and from 1.5 to 8 in another embodiment, and from 1.8 to 5 in yet another embodiment, and from 2.0 to 3.5 in another embodiment, and from 2.2 to 3.0 in yet another embodiment; and the die gap can be within a range of from 0.5 to 9 mm in one embodiment, and from 0.8 to 5 mm in another embodiment, and from 0.8 to 3 mm in yet another embodiment, and from 1.0 to 2.0 mm in yet another embodiment. The film thickness may be preferentially in the range of from about 200 to about 750 μm.

Regarding Step 2030, the first bubble may be cooled and collapsed using any suitable technique or equipment to form a primary tube. Cooling may be done before bubble is collapsed. For example, the bubble may be quenched by using water, for example, in the form of a cascade spray and/or immersion bath and/or one or more rollers may be used to flatten the bubble. Alternatively, cool air may be blown on the melt, while the warm air is extracted via the exhaust pipe. In certain embodiments of the film blowing process, the polymeric resin melt is simultaneously cooled on the outside by a dual lip air ring. This air ring provides the main cooling and sets the frost line. The cooling air can be refrigerated in a heat exchanger connected to the chilled water circuit of the site. The bubble is stabilized in the calibration basket in certain embodiments, wherein the bubble then enters the collapsing stage.

Regarding Step 2040, the primary tube may be heated. Any suitable technique may be used to heat the polymeric resin. For example, one or more radiant heaters or ovens may be used. In one particular embodiment, the primary tube is fed through a series of ovens so as to gradually increase the temperature of the tube. The ovens may be uniformly heated or set at different temperatures. In one embodiment, the oven temperatures vary in small increments, such as about +/−10° C., or about +/−5° C., or about +/−2° C. In accordance with an aspect of the invention, the crystallinity of the first bubble will define the required oven temperature settings. The higher the crystallinity, the higher the oven temperature required. In accordance with an embodiment, the tube is heated to a temperature such that it (i) has a suitable melt strength to create and maintain the second bubble; and (ii) is drawable and orientable when stretched. The primary tube may be also cross linked by gamma or beta irradiation before heating and inflation steps. After cross linking, the first bubble may have required suitable melt strength to form and maintain the second bubble.

Regarding Step 2050, the second bubble may be formed after heating the primary tube and introducing air to inflate the tube.

In an embodiment, the film is oriented (in whole) in both the machine direction (MD) and transverse direction (TD). The orientation is defined by a combination of the output of the extruders, the winder speed and the width of the secondary bubble versus the primary bubble. Regarding Step 2060, the second bubble may be quenched and then collapsed using one or more rollers.

In various embodiments, the double-bubble extrusion process may further comprise one or more of: (i) annealing the film; (ii) slitting the film to form a plurality of films; and/or (iii) winding the film onto a roller.

The above-described processes are intended for illustrative purposes only. Other useful double-bubble extrusion techniques are disclosed, for example, in U.S. Pat. No. 6,423,420 entitled “Oriented Extruded Films” (Brant et al.) and U.S. Pat. No. 3,456,044 entitled “Biaxial Orientation” (Pahlke), which are herein incorporated by reference for this purpose.

One or more of the layers of the film may be oriented in the transverse and/or longitudinal directions to the same or different extents. This orientation may occur before or after the individual layers are brought together. For example, a polyethylene layer can be extrusion coated or laminated onto an oriented polypropylene layer or the polyethylene and polypropylene can be coextruded together into a film then oriented. Likewise, oriented polypropylene could be laminated to oriented polyethylene or oriented polyethylene could be coated onto polypropylene then optionally, the combination could be oriented even further. Typically, the films are oriented in the MD at a ratio of up to 15, preferably between 5 and 7, and in the TD at a ratio of up to 15 preferably 7 to 9. However, in another embodiment, the film is oriented to the same extent in both the MD and TD directions.

More particularly, a method for forming the multilayer polymeric film comprises:

(a) forming at least one layer A by extruding a first polymeric resin comprising propylene derived units to form an extrudate, wherein the first polymeric resin has: (i) a propylene derived unit content of greater than 90 weight %, based on the weight of the first polymeric resin; (ii) a Tm of greater than 120° C.; and (iii) a MFR in the range of from about 0.1 to about 100 g/10 min; and
(b) forming at least one layer B by extruding a second polymeric resin comprising ethylene derived units to form an extrudate, wherein the second polymeric resin has: (i) a density in the range of from about 0.905 to about 0.945 g/cm³; (ii) an ethylene derived unit content of greater than 50 weight %, based on the weight of the second polymeric resin; (iii) a CDBI of greater than 50%; (iv) a MI in the range of from about 0.1 to about 5.0 g/10 min; and (v) a g′ of greater than about 0.7; and
wherein at least one of layers A and B further comprises at least one copolymer of propylene derived units and at least one C₂, and C₄ to C₁₀ alpha-olefin derived units, the copolymer having: (a) a C₂, and/or C₄ to C₁₀ alpha-olefin derived unit content in the range of about 5 to about 30 weight %; (b) an intermolecular composition distribution of greater than or equal to 75%; (c) a Tm in the range of from about 25° C. to about 110° C.; (d) a Hf in the range of from about 0.5 to about 70 J/g; (e) a Mw/Mn in the range of from about 1.2 to about 4.5; and (f) a MFR in the range of from about 0.1 to about 40 g/10 min; and
wherein each layer is oriented to the same or different extents, and the layers are combined to form the multilayer film.

Even more particularly, a method for forming a multilayer polymeric film comprises: (1) forming at least one layer A by extruding a first polymeric resin comprising propylene derived units to form an extrudate, wherein the first polymeric resin has: (i) a propylene derived unit content of greater than 90 weight %, based on the weight of the first polymeric resin; (ii) a Tm of greater than 120° C.; (iii) a MFR in the range of from about 0.1 to about 100 g/10 min; and (2) forming at least one layer B by extruding a second polymeric resin comprising ethylene derived units to form an extrudate, wherein the second polymeric resin has: (i) a density in the range of from about 0.905 to about 0.980 g/cm³; (ii) an ethylene derived unit content of greater than 50 weight %, based on the weight of the second polymeric resin; and wherein at least one of layers A and B further comprises at least one copolymer of propylene derived units and at least one C₂, and C₄ to C₁₀ alpha-olefin derived units, the copolymer having: (a) a C₂, and/or C₄ to C₁₀ alpha-olefin derived unit content in the range of about 5 to about 30 weight %; (b) an intermolecular composition distribution of greater than or equal to 75%; (c) a Tm in the range of from about 25° C. to about 110° C.; (d) a Hf in the range of from about 0.5 to about 70 J/g; (e) a Mw/Mn in the range of from about 1.2 to about 4.5; and (f) a MFR in the range of from about 0.1 to about 40 g/10 min; and wherein each layer is oriented to the same or different extents; and wherein the orientation comprises: (a) inflating each extrudate to form a first bubble; (b) cooling and collapsing the first bubble to form a primary tube; (c) heating the primary tube; (d) inflating the primary tube to form a second bubble, wherein the second bubble at least partially biaxially orients the film; and (e) cooling and collapsing the second bubble; and (3) combining the layers to form the multilayer polymeric film.

In embodiments herein, the copolymer of propylene derived units and one or more C₂, and C₄ to C₁₀ alpha-olefin derived units is made using a metallocene catalyst.

In some embodiments, the layers are laminated, by extrusion lamination, to form the multilayer polymeric film. In other embodiments, the layers are co-extruded to form the multilayer polymeric film.

In some embodiments herein, articles comprising the multilayer polymeric film are useful. In some embodiments herein, packaging film comprising the multilayer polymeric film is useful. In some embodiments, the packaging film is a shrink wrap film.

### Film Properties, Tests and Methods

The films made from the compositions of the present invention have a new and useful combination of properties that allow them to be used as elastic films and enable them to be extruded by blown film equipment with good bubble stability. Any of layers A or B may be modified with at least one copolymer of propylene derived units and at least one of C₂, and C₄ to C₁₀ alpha-olefin monomer derived units.

Films herein have one or more of the following properties: (i) a ratio of energy at break (MD/TD) less than 1.50, less than 1.25, or less than 1.0; (ii) a tensile strength greater than 45 MPa, greater than 55 MPa, preferably greater than 85 MPa; (iii) a elongation at break greater than 80%, greater than 90%, preferably greater than 95% in the MD; (iv) a ratio of the elongation at break (MD/TD) in the range of from about 0.75 to about 1.5, preferably from about 0.80 to about 1.0; (v) a 1% secant modulus less than 400 MPa, less than 375 MPa, or less than 360 MPa, in both the MD and TD; (vi) a dart impact strength greater 200 g, greater than 250 g, greater than 300 g, or preferably greater than 350 g; (vii) a puncture resistance greater than 25 mJ/μm, greater than 40 mJ/μm, or preferably greater than 60 mJ/μm; (viii) a seal strength greater than 6.25 N/cm, at a dwell time of 0.75 seconds; greater than 6.5 N/cm; greater than 7.0 N/cm; greater than 8.0 N/cm; or greater than 10.0 N/cm; (ix) a 10% or greater shrinkage than a reference film, at a given temperature, where the reference film does not have the copolymer of propylene derived units and one or more C₂, and C₄ to C₁₀ alpha-olefin derived units present in any of the layers; (x) a 10% or greater shrinkage than a reference film, at a temperature in the range of from about 90° C. to about 120° C., where the reference film does not have the copolymer of propylene derived units and one or more C₂, and C₄ to C₁₀ alpha-olefin derived units present in any of the layers; (xi) a MD shrinkage/TD shrinkage in the range of from about 0.68 to about 0.90, or preferably about 0.68 to about 0.80, at a temperature in the range of from about 90° C. to about 120° C.; (xii) a percent shrinkage of greater than 70% in both the MD and TD, at a temperature of 150° C.; (xiii) a gloss 45° of greater than 75, greater than 80, or greater than 83; (xiv) a clarity of at least 75, at least 80, or at least 84; and (xv) a haze of less than 5.0, less than 4.0, less than 1.5, less than 1.4, or less than 1.3. This new and useful combination of properties includes mechanical and optical properties, each discussed in turn, below.

### Mechanical Properties

Mechanical properties of the multilayer polymeric films of the present invention include tensile properties, dart impact, puncture resistance, seal strength, and shrinkage properties, such as % shrinkage. Improved mechanical properties are desirable, especially in the blown film industry, to ensure package integrity during packaging and transportation of goods.

Tensile properties discussed herein include energy at break, tensile strength at break (also called break stress), elongation at break, and 1% secant modulus (also called flexural modulus). Tensile properties are evaluated at the point where load deformation causes failure of film. Energy at break (MPa) is the energy absorbed at the breaking point. “Tensile strength” (MPa) is breaking force (N)/cross-sectional area of sample (mm²) “Elongation at break” (%)=increase in length at breaking point (mm)/original length (mm)×100%. “1% Secant modulus” (MPa) is the ratio of stress to strain in flexural deformation. Tensile properties are measured using ASTM D-882, using a Zwick™ testing machine, except that tensile properties of films 1.0 mm or greater in thickness are measured according to ASTM D-638. Without wishing to be bound by theory, the inventors surmise that in certain embodiments, where the copolymer of propylene derived units and one or more C₂, and C₄ to C₁₀ alpha-olefin derived units is present in the skin layer, the copolymer serves to reduce the secant modulus of the skin layer, thereby making the secant modulus of the skin layer comparable to that of the core layer. The inventors speculate that a marked difference in 1% secant modulus between two layers may make the film structure weaker. Accordingly, by serving to reduce the secant modulus of the skin layer, the copolymer of propylene derived units and one or more C₂, and C₄ to C₁₀ alpha-olefin derived units may provide a tougher film. In embodiments herein, the ratio of energy at break (MD/TD) is less than 1.50, less than 1.25, or less than 1.0. In embodiments herein, tensile strength is greater than 45 MPa, greater than 55 MPa, preferably greater than 85 MPa. In embodiments herein, elongation at break is greater than 80%, greater than 90%, preferably greater than 95% in the MD. In other embodiments, the ratio of the elongation at break (MD/TD) is in the range of from about 0.75 to about 1.5, preferably from about 0.80 to about 1.0. In some embodiments, the 1% secant modulus is less than 400 MPa, less than 375 MPa, or less than 360 MPa in both the MD and TD.

Falling dart impact is a traditional method for evaluating the impact strength or toughness of a plastic film. Dart impact strength (g) of multilayer polymeric films herein was determined per ASTM D-1709. Tables 2 and 3 show that with increasing Vistamaxx™ content in the skin layers (Films 1 and 2), dart impact strength of the film improved significantly compared with a film that does not have Vistamaxx™ in the skin layers (Reference Film). In embodiments herein, dart impact strength is greater 200 g, greater than 250 g, greater than 300 g, or preferably greater than 350 g.

Puncture resistance is the measure of the energy-absorbing ability of the stretch wrap film in resisting protrusion. Puncture resistance (mJ/μm) of multilayer polymeric films herein was determined per ASTM D-5748. The inventors have surprisingly found that the inventive films display greater puncture resistance than the reference films. Blending a copolymer of propylene and one or more C₂, and C₄ to C₁₀ alpha-olefins into the skin layers of the film appears to improve puncture resistance. In Table 2, it is observed that with increasing Vistamaxx™ content in the skin layers, puncture resistance of the film improved significantly compared with a film that does not have Vistamaxx™ in the skin layers. In embodiments herein, puncture resistance is greater than 25 mJ/μm, greater than 40 mJ/μm, or preferably greater than 60 mJ/μm.

The seal strength is the force required to separate the heat sealed packaging. Improved seal integrity is beneficial for achieving higher packaging speed on automatic packaging lines. Seal strength sample preparation is as indicated in ASTM F-2029. Films are sealed on an impulse sealing apparatus, with an impulse sealing bar composed of Ni/Cr (80/20) heated wire. The seal bar temperature is 260° C., at a seal pressure of 20 kg. The dwell time for the sealing is 0.5 seconds or 0.75 seconds. The inventors have found that a seal time of 0.75 seconds is preferable for forming a seal with a seal strength of 6.25 N/cm or higher. Specimens are cut from the sealed film that are 20 mm wide and 200 mm long. Specimens are tested on a dynamometer (Instron Model/load cell), according to the following method. The heat seal strength was measured at a pulling rate of 50 mm/min, the maximum value of strength being reported. Elongation at break was also determined, as disclosed above.

Typically, the failure mode of such packaging tends to be delamination of the heat seal outer layer from the inner layer. Many films used for packaging have a PP/PE/PP layer configuration (where PP is polypropylene and PE is polyethylene). Intrinsic compatibility between PP and PE tends to be poor, therefore, layer delamination may become an issue. Accordingly, increasing the interlayer bonding strength between the heat seal outer layer and the inner layer may improve the seal strength of the multilayer polymeric film. Therefore, assuming a good heat seal has been made, the seal strength may reflect the strength of the interlayer bond between the inner layer and the heat seal outer layer. The inventors have surprisingly found that the multilayer films of the present invention demonstrate improved seal strength properties, when compared to a reference film. Without wishing to be bound by theory, the inventors surmise that in certain embodiments, where the copolymer of propylene derived units and one or more C₂, and C₄ to C₁₀ alpha-olefin derived units is present in the skin layer, the copolymer serves to make the skin layer more compatible with the core layer. In the examples, where the copolymer is a propylene/ethylene copolymer and is blended into the skin layer, better seal strength is observed. Accordingly, the copolymer of propylene derived units and one or more C₂, and C₄ to C₁₀ alpha-olefin derived units may serve to improve the interlayer bonding strength and therefore improve seal strength. In embodiments herein, seal strength is greater than 6.25 N/cm, at a dwell time of 0.75 seconds; greater than 6.5 N/cm; greater than 7.0 N/cm; greater than 8.0 N/cm; or greater than 10.0 N/cm.

Linear thermal shrink, or free shrink, is a measure of the effect of temperature on films, measured herein using a Betex Shrink method. The Betex Shrink method determines the degree of unrestrained linear thermal shrinkage of a plastic film or sheet. The results are normally reported as %, where a negative result indicates that the sample has expanded rather than contracted. A film sample, measuring approximately 50 mm×50 mm in diameter, was submerged in silicone oil and placed on a hot plate at a certain temperature, for example, 90° C., 110° C., 130° C., or 150° C. The silicone oil was applied between the film samples and the heated surface to prevent the samples from sticking to the heating plate and allowing a free shrinkage movement. When the sample stopped shrinking, the sample was removed and dimensions of the shrunken sample measured. The percentage of shrinkage, in both the machine direction (MD) and transverse direction (TD), at that particular temperature is calculated.

The inventors have surprisingly found that the multilayer films of the present invention demonstrate improved shrinkage properties, when compared to a reference film. In particular, the inventive films demonstrate higher shrinkage at a given temperature. Also, the inventive films demonstrate the same amount of shrinkage at a lower temperature. These properties afford the ability to lower the shrink tunnel temperature to achieve a set shrink ratio. Lower shrinkage temperatures are especially beneficial when packaging heat sensitive products, such as frozen foods. Being able to package at lower shrinkage temperatures ensures that the quality of the heat sensitive product remains substantially unchanged. In some embodiments herein, the inventive films show 10% or greater shrinkage than a reference film, at a given temperature, where the reference film does not have the copolymer of propylene derived units and one or more C₂, and C₄ to C₁₀ alpha-olefin derived units present in any of the layers. In other embodiments herein, the inventive films show 10% or greater shrinkage than a reference film, at a temperature in the range of from about 90° C. to about 120° C., where the reference film does not have the copolymer of propylene derived units and one or more C₂, and C₄ to C₁₀ alpha-olefin derived units present in any of the layers. In other embodiments herein, the inventive films have a MD shrinkage/TD shrinkage in the range of from about 0.68 to about 0.90, or preferably about 0.68 to about 0.80, at a temperature in the range of from about 90° C. to about 120° C. In yet other embodiments, the inventive films have a percent shrinkage of greater than 70% in both the MD and TD, at a temperature of 150° C.

### Optical Properties

Good gloss, clarity, and haze are desirable optical properties in multilayer polymer films, especially those used in packaging applications. Multilayer films disclosed herein demonstrate comparative or improved optical properties, as compared to a reference film.

Gloss provides information about the shininess or gloss of the film. Gloss measurement involves specular reflection, which is a sharp light beam reflecting from the film surface, at a specific angle of incidence, herein 45°. Gloss usually varies as a function of surface smoothness and flatness. Gloss 45° of the multilayer polymeric films disclosed herein was determined as per ASTM D-2457. The inventive films have comparative gloss to the reference films as disclosed herein in Table 3. In embodiments herein, the inventive films have a gloss 45° of greater than 75, greater than 80, or greater than 83.

The clarity of a film, nominally clear and colorless, can be compared with its ability to transmit image-forming light. It may be thought of as the distinctness with which an object appears when viewed through the material. Therefore, clarity depends on the linearity of the passage of light rays through the material. Poor clarity is thought to be related to surface defects. Clarity is determined by small-angle scattering, and is measured as per ASTM D-1746. The inventive films have comparative gloss to the reference films as disclosed in Table 3. In some embodiments herein, inventive films have a clarity of at least 75, at least 80, or at least 84.

Haze is the percentage of transmitted light that, in passing through a specimen, deviates from the incident beam by forward scattering. Only light flux deviating more than 2.5° on the average is considered to be haze. The contrast of an object seen through a film decreases with increasing haze. Haze of the multilayer polymeric films herein was determined as per ASTM D-1003. The inventors have surprisingly found that the multilayer films of the present invention demonstrate improved haze, when compared to a reference film, disclosed in Table 3. In embodiments herein, the haze is less than 5.0, less than 4.0, less than 1.5, less than 1.4, or less than 1.3.

### EXAMPLES

The new and useful combination of properties of the films described herein will now be further illustrated with reference to the following examples.

### Tests and Materials

The various properties, as determined by the test methods above, are measured with respect to A/B/A-type multilayer polymeric films, having a polyethylene core layer and two polypropylene-based skin layers in a layer configuration of polypropylene/polyethylene/polypropylene. Various amounts of at least one copolymer of propylene derived units and at least one C₂, and C₄ to C₁₀ alpha-olefin derived units are blended into at least one layer of the film, as described below.

The overall thickness of the film is about 19 μm. The thickness distribution was varied as noted in the examples below.

Table 2 provides a listing of component materials used in the films of Examples 1 and 2.

TABLE 2
Components of Example Films 1-5

| Component | Brief Description | | Commercial Source |
|---|---|---|---|
| ENABLE ™ 20-05CH (m-PE) | Ethylene-hexene | MI = 0.5 g/10 min, | ExxonMobil Chemical |
| | copolymer, | density = 0.920 | Company |
| | metallocene- | g/cm³ | |
| ENABLE ™ 27-05CH (m-PE) | catalyzed, UNIPOL ™ | MI = 0.5 g/10 min, | ExxonMobil Chemical |
| | process. | density = 0.927 | Company |
| | | g/cm³, | |
| Vistamaxx ™ 3980FL | Propylene-based | MI = 3.6 g/10 min, | ExxonMobil Chemical |
| | copolymer primarily | density = 0.879 | Company |
| | composed of | g/cm³ | |
| Vistamaxx ™ 3020FL | isotactic propylene | MI = 0.9 g/10 min, | ExxonMobil Chemical |
| | repeat units with | density = 0.874 | Company |
| | random ethylene | g/cm³ | |
| Vistamaxx ™ 6102FL | distribution, | MI = 1.3 g/10 min, | ExxonMobil Chemical |
| | metallocene | density = 0.862 | Company |
| | catalyzed, | g/cm³ | |
| | EXXPOL ™ Catalyst | | |
| | Technology. | | |

| | | |
|---|---|---|
| ADSYL 5 C 37 F | Propylene-Ethylene-Butene Terpolymer, | LyondellBasell |
| | MFR = 5.5 g/10 min (230° C., 2.16 kg), | Polymers |
| | density = 0.902 g/cm³ | |
| CLYRELL RC213M | Polypropylene random copolymer, MFR = | LyondellBasell |
| | 10 g/10 min; density = 0.900 g/cm³ | Polymers |

As used above, “UNIPOL™ process” refers to a polymerization process licensed by Univation Technologies, a joint venture between ExxonMobil Chemical Company and The Dow Chemical Company for manufacturing olefin-based polymers, namely, polyethylene (PE) and polypropylene (PP).

### Example 1

### Vistamaxx™ in One or More Skin Layers and Vistamaxx™ in the Core Layer

For Films 1 to 5 and Reference Film 1, the thickness distribution of the layers is 1/4/1.

### Films 1 and 2: Vistamaxx™ in One or More Skin Layers

Multilayer Film 1 comprising 10 weight % Vistamaxx™ 3980FL (propylene copolymer) in both skin layers and Film 2, comprising 30 weight % Vistamaxx™ 3980FL in one skin layer, were compared with a Reference Film 1 comprising ADSYL 5 C 37 F (a propylene-based terpolymer) in both skin layers. All of Films 1 and 2, and the Reference Film 1 had a core comprising 100 weight % Enable™ 20-05CH (polyethylene-based).

### Films 3, 4 and 5: Vistamaxx™ in the Core Layer

Multilayer Film 3 comprising 30 weight % Vistamaxx™ 3020FL and 70 weight % Enable™ 20-05CH in the core layer; Film 4 comprising 50 weight % Vistamaxx™ 3020FL and 50 weight % Enable™ 20-05CH in the core layer; and Film 5 comprising 25 weight % Vistamaxx™ 6102FL and 75 weight % Enable™ 20-05CH in the core layer; were compared to a Reference Film 1 comprising 100 weight % Enable™ 20-05CH in the core layer. All of Films 3, 4, 5, and the Reference Film 1 had both skin layers comprising 100 weight % ADSYL 5 C 37 F.

Films 1-5 and the Reference Film 1 were tested for various mechanical, optical and heat shrinkage properties, as reported in Table 3 below.

TABLE 3
PROPERTIES OF FILMS 1-5 TO REFERENCE FILM 1

| FILM | | | RF 1 | 1 | 2 | 3 | 4 | 5 |
|---|---|---|---|---|---|---|---|---|
| Composition | | Skin 1 | 100% | 10% | 30% | 100% | 100% | 100% |
| of Layers | | (Inner) | ADSYL | Vistamaxx ™ | Vistamaxx ™ | ADSYL | ADSYL | ADSYL |
| | | | 5 C 37 F | 3980FL + | 3980FL + | 5 C 37 F | 5 C 37 F | 5 C 37 F |
| | | | | 90% | 70% | | | |
| | | | | ADSYL | ADSYL | | | |
| | | | | 5 C 37 F | 5 C 37 F | | | |
| | | Core | ENABLE ™ | ENABLE ™ | ENABLE ™ | 30% | 50% | 20% |
| | | | 20-05CH | 20-05CH | 20-05CH | Vistamaxx ™ | Vistamaxx ™ | Vistamaxx ™ |
| | | | (m-PE) | (m-PE) | (m-PE) | 3020FL + | 3020FL + | 6102FL + |
| | | | | | | 70% | 50% | 80% |
| | | | | | | ENABLE ™ | ENABLE ™ | ENABLE ™ |
| | | | | | | 20-05CH | 20-05CH | 20-05CH |
| | | | | | | (m-PE) | (m-PE) | (m-PE) |
| | | Skin 2 | 100% | 10% | 100% | 100% | 100% | 100% |
| | | (Outer) | ADSYL | Vistamaxx ™ | ADSYL | ADSYL | ADSYL | ADSYL |
| | | | 5 C 37 F | 3980FL + | 5 C 37 F | 5 C 37 F | 5 C 37 F | 5 C 37 F |
| | | | | 90% | | | | |
| | | | | ADSYL | | | | |
| | | | | 5 C 37 F | | | | |
| Energy at Break MD/TD | | | 41.8/26.4 | 46.9/57.3 | 90.4/96.1 | 65.8/48.2 | 41.4/38.3 | 48.1/40.7 |
| (MPa) | | | | | | | | |
| Elongation at Break | | | 76/182 | 86/58 | 96/105 | 86/103 | 97/76 | 78/85 |
| MD/TD (%) | | | | | | | | |
| 1% Secant Modulus | | | 411/352 | 427/505 | 366/344 | 344/321 | 300/321 | 329/338 |
| MD/TD (MPa) | | | | | | | | |
| Puncture Resistance | | | 18 | 28 | 61 | 28 | 16 | 23 |
| (mJ/μm) | | | | | | | | |
| Dart Impact (g) | | | 161 | 244 | 393 | 228 | 195 | 225 |
| Seal | DT | 0.5 | 6.47 | 6.67 | 10.00 | 7.44 | 6.17 | 6.44 |
| Strength | (s) | 0.75 | 5.94 | 7.74 | 12.89 | 9.59 | 6.46 | 6.60 |
| (N/cm) | | | | | | | | |
| Seal | | 0.5 | 65.2 | 67.9 | 34.8 | 39.4 | 56.0 | 53.6 |
| Elongation | | 0.75 | 82.6 | 77.1 | 52.8 | 47.1 | 53.7 | 52.3 |
| (%) | | | | | | | | |

| Clarity | | 82 | 84 | 85 | 78 | 82 | 84 |
|---|---|---|---|---|---|---|---|
| Haze | | 1.86 | 1.45 | 1.35 | 1.66 | 2.01 | 1.75 |
| Gloss 45° | | 92.8 | 92.2 | 84.2 | 90.8 | 91.0 | 88.1 |
| Shrinkage | 90° C. | 2/0 | 5/4 | 10/7 | — | — | — |
| MD/TD (%) | 110° C. | 21/14 | 26/18 | 34/26 | — | — | — |
| | 130° C. | 63/54 | 64/61 | 69/66 | — | — | — |
| | 150° C. | 70/66 | 74/72 | 74/60 | 74/60 | 67/62 | 71/64 |

KEY:
RF 1 = Reference Film 1;
DT = Dwell Time;
MD = machine direction;
TD = transverse direction.

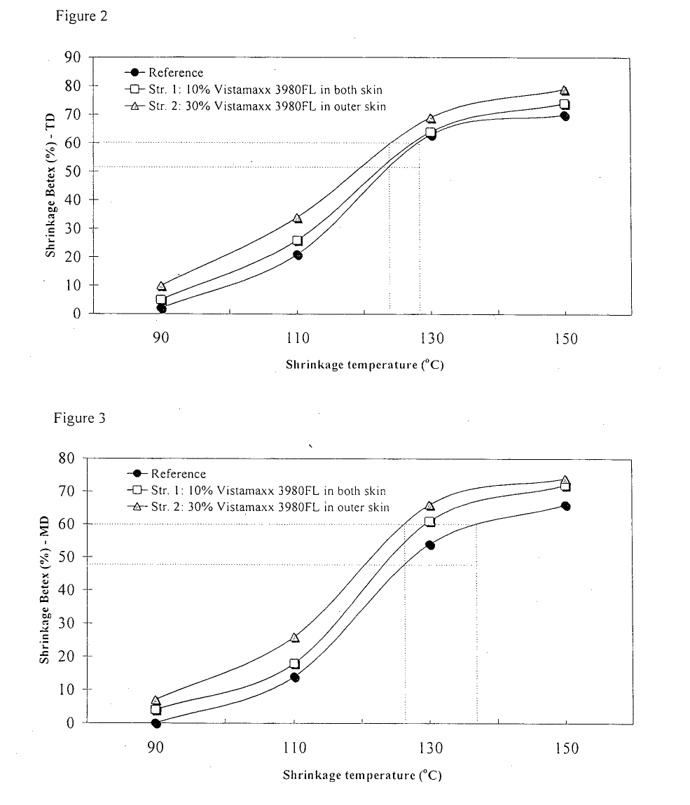

Table 3 shows that inventive Films 1 and 2 demonstrate significant improvements in mechanical properties such as tensile strength at break, elongation at break, dart impact, and puncture resistance when compared to the Reference Film 1. Films 1 and 2 also demonstrate excellent optical properties such as gloss 45° and clarity, and improved haze, when compared to the Reference Film 1. FIGS. 2 and 3 further show that the inventive films 1 and 2 demonstrate higher shrinkage at a given temperature.

Table 3 also shows that films having the skin layer modified with Vistamaxx™ that is Films 1 and 2, demonstrate better mechanical, optical, and heat shrinkage properties than films having the core layer modified with Vistamaxx™, such as Films 3, 4, and 5.

### Example 2

### Vistamaxx™ in Both Skin Layers; No Terpolymer

For multilayer Film 6 and Reference Film 2, the thickness distribution of the layers is 15/70/15.

Multilayer Film 6 comprising 30 weight % Vistamaxx™ 3020FL and 70 weight % CLYRELL RC213M (a propylene-based random copolymer) in both skin layers was compared to a Reference Film 2 comprising 100% ADSYL 5 C 37 F (a propylene-based terpolymer) in both skin layers. Both Film 6 and the Reference Film 2 had a core layer comprising 100 weight % Enable™ 27-05CH.

Film 6 and the Reference Film 2 were tested for various mechanical, optical and heat shrinkage properties, as reported in Table 4 below.

TABLE 4
PROPERTIES OF FILM 6 COMPARED
TO REFERENCE FILM 2

| FILM | | RF2 | 6 |
|---|---|---|---|
| Composition | Skin 1 | 100% ADSYL 5 C 37 F | 30% Vistamaxx ™ |
| of Layers | | | 3020FL + 70% |
| | | | CLYRELL |
| | | | RC213M |
| | Core | ENABLE ™ 27- | ENABLE ™ 27- |
| | | 05CH (m-PE) | 05CH (m-PE) |
| | Skin 2 | 100% ADSYL 5 C 37 F | 30% Vistamaxx ™ |
| | | | 3020FL + 70% |
| | | | CLYRELL |
| | | | RC213M |

| | | |
|---|---|---|
| Tensile Strength | 98.6 | 96 |
| at Break (MPa) | | |
| Elongation at | 90 | 85 |
| Break (%) | | |
| 1% Secant Modulus | 677/760 | 604/636 |
| (MD/TD) (MPa) | | |
| Dart Impact (g) | 147 | 272.69 |
| Puncture | 53 | 55 |
| Resistance (mJ/μm) | | |
| Haze | 3.97 | 4.83 |
| Shrinkage | 74/71 | 76/71 |
| MD/TD (%) | | |

KEY: RF 2 = Reference Film 2; MD = machine direction; TD = transverse direction

When compared to the Reference Film 2, Film 6 demonstrates higher dart impact strength and puncture resistance. Film 6 also exhibits similar or higher performance compared to the reference film for all other film properties tested.

All documents described herein are incorporated by reference herein, including any priority documents and/or testing procedures to the extent they are not inconsistent with this text, provided however that any priority document not named in the initially filed application or filing documents is NOT incorporated by reference herein. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including” for purposes of Australian law. Likewise, “comprising” encompasses the terms “consisting essentially of,” “is,” and “consisting of” and anyplace “comprising” is used “consisting essentially of,” “is,” or “consisting of” may be substituted therefor.

We claim:

1. A multilayer polymeric film comprising:
at least one layer A, comprising a first polymeric resin, the first polymeric resin comprising propylene derived units and having:
(1) a propylene derived unit content of greater than 90 weight %, based on the weight of the first polymeric resin;
(2) a peak melting temperature (Tm) of greater than 120° C.; and
(3) a melt flow rate (MFR) in the range of from about 0.1 to about 100 g/10 min; and
at least one layer B, comprising a second polymeric resin, the second polymeric resin comprising ethylene derived units and having:
(a) a density in the range of about 0.905 to about 0.945 g/cm³;
(b) an ethylene derived unit content of greater than 50 weight %, based on the weight of the second polymeric resin;
(c) a composition distribution breadth index (CDBI) of greater than 50%;
(d) a melt index (MI) in the range of about 0.1 to about 5.0 g/10 min; and
(e) a branching index (g′) of greater than about 0.7; and
wherein at least one of layers A and B further comprises at least one copolymer of propylene derived units and one or more C₂, and C₄ to C₁₀ alpha-olefin derived units, the copolymer having:
(a) a C₂, and/or C₄ to C₁₀ alpha-olefin derived unit content in the range of about 5 to 30 weight %;
(b) an intermolecular composition distribution of greater than or equal to 75%;
(c) a peak melting temperature (Tm) in the range of from about 25° C. to about 110° C.;
(d) a heat of fusion (Hf) in the range of from about 0.5 to about 70 J/g;
(e) a molecular weight distribution (Mw/Mn) in the range of from about 1.2 to about 4.5; and
(f) a melt flow rate (MFR) in the range of from about 0.1 to about 40 g/10 min; and wherein the multilayer polymeric film has a seal strength greater than 6.25 N/cm at a dwell time of 0.75 seconds.

2. The multilayer polymeric film of claim 1, wherein the copolymer of propylene derived units and one or more C₂, and C₄ to C₁₀ alpha-olefin derived units is made using a metallocene catalyst.

3. The multilayer polymeric film of any of the preceding claims, wherein the copolymer of propylene derived units and one or more C₂, and C₄ to C₁₀ alpha-olefin derived units has a g′ of about 0.99 or greater.

4. The multilayer polymeric film of any of the preceding claims, wherein the copolymer of propylene derived units and one or more C₂, and C₄ to C₁₀ alpha-olefin derived units may have any of (i) a crystallization temperature (Tc) of about 200° C. or less; (ii) a density in the range of from about 0.85 to about 0.92 g/cm³; (iii) percent crystallinity in the range of from 0.25% to 40%; (iv) an mm triad tacticity index of 75% or greater; (v) a substantial absence of ¹³C nuclear magnetic resonance (NMR) peaks corresponding to a regio-error at about 14.6 and about 15.7 ppm, the peaks being of about equal intensity; (vi) a m/r of more than 1; and (vii) a Mooney viscosity of less than 100.

5. The multilayer polymeric film of any of the preceding claims, wherein the second polymeric resin comprising ethylene-derived units has one or more of the following additional properties: (a) a melt strength (MS) of greater than about 2.0 cN; (b) a relation between melt index (MI) (in g/10 min) and MS (in cN) according to the formula: MS=−2.6204*MI+7.5686; and (c) a melt index ratio (MIR) in the range of from about 25 to about 80.

6. The multilayer polymeric film of any of the preceding claims, wherein the first polymeric resin is a propylene-based terpolymer.

7. The multilayer polymeric film of any of the preceding claims, wherein the first polymeric resin is a propylene/ethylene/butene terpolymer.

8. The multilayer polymeric film of any of the preceding claims, wherein the first polymeric resin is a random propylene-based copolymer.

9. The multilayer polymeric film of any of the preceding claims, wherein the film comprises a combination of one or more of layer A and one or more of layer B arranged in a layer configuration that is selected from the group consisting of: (A/B/A), (A/A/B/A/A), (A/B/B/B/A), (A/B/B/B/B/B/A), (A/A/B/B/B/A/A), (A/A/A/B/A/A/A), (A/B/B/B/B/A), (A/A/B/B/B/A/A), and other variants comprising from 3, 4, 5, 6, 7, 8, or more layers.

10. The multilayer polymeric film of any of the preceding claims, wherein the second polymeric resin is made using a metallocene catalyst.

11. The multilayer polymeric film of any of the preceding claims, wherein the second polymeric resin is linear low density polyethylene (LLDPE).

12. The multilayer polymeric film of any of the preceding claims, wherein the copolymer of propylene derived units and one or more C₂, and C₄ to C₁₀ alpha-olefin derived units is a propylene/ethylene copolymer.

13. The multilayer polymeric film of any of the preceding claims, wherein at least one layer A comprises the copolymer of propylene derived units and one or more C₂, and C₄ to C₁₀ alpha-olefin derived units.

14. The multilayer polymeric film of any of the preceding claims, wherein all layers A comprise the copolymer of propylene derived units and one or more C₂, and C₄ to C₁₀ alpha-olefin derived units.

15. The multilayer polymeric film of any of the preceding claims, wherein the copolymer of propylene derived units and one or more C₂, and C₄ to C₁₀ alpha-olefin derived units comprises at least 10 weight % of at least one layer.

16. The multilayer polymeric film of any of the preceding claims, wherein the copolymer of propylene derived units and one or more C₂, and C₄ to C₁₀ alpha-olefin derived units comprises at least 30 weight % of at least one layer.

17. The multilayer polymeric film of any of the preceding claims, wherein the copolymer of propylene derived units and one or more C₂, and C₄ to C₁₀ alpha-olefin derived units comprises less than 50 weight % of at least one layer.

18. The multilayer polymeric film of any of the preceding claims, wherein the copolymer of propylene derived units and one or more C₂, and C₄ to C₁₀ alpha-olefin derived units comprises less than 30 weight % of at least one layer.

19. The multilayer polymeric film of any of the preceding claims, wherein the dart impact strength, as determined by ASTM D-1709, is greater than 200 g.

20. The multilayer polymeric film of any of the preceding claims, wherein the shrinkage is greater than 70%, at 150° C. in both the machine direction and the transverse direction.

21. The multilayer polymeric film of any of the preceding claims, wherein the MD shrinkage/TD shrinkage is in the range of from about 0.6 to about 0.90, at a temperature in the range of from about 90° C. to about 120° C.

22. The multilayer polymeric film of any of the preceding claims, wherein the puncture resistance, as determined by ASTM D-5748, is greater than 25 mJ/μm.

23. The multilayer polymeric film of any of the preceding claims, wherein the seal strength, is greater than 6.25 N/cm, at a dwell time of 0.75 seconds.

24. A method for forming the multilayer polymeric film of any of the preceding claims, comprising:
(1) forming at least one layer A by extruding a first polymeric resin comprising propylene-derived units to form an extrudate,
wherein the first polymeric resin has:
(i) a propylene derived unit content of greater than 90 weight %, based on the weight of the first polymeric resin;
(ii) a Tm of greater than 120° C.;
(iii) a MFR in the range of from about 0.1 to about 100 g/10 min; and
(2) forming at least one layer B by extruding a second polymeric resin comprising ethylene-derived units to form an extrudate,
wherein the second polymeric resin has:
(i) a density in the range of from about 0.905 to about 0.945 g/cm³;
(ii) an ethylene derived unit content of greater than 50 weight %, based on the weight of the second polymeric resin;
(iii) a CDBI of greater than 50%;
(iv) a MI in the range of from about 0.1 to about 5.0 g/10 min; and
(v) a g′ of greater than about 0.7; and
wherein at least one of layers A and B further comprises at least one copolymer of propylene derived units and at least one C₂, and C₄ to C₁₀ alpha-olefin derived units, the copolymer having:
(a) a C₂, and/or C₄ to C₁₀ alpha-olefin derived unit content in the range of about 5 to about 30 weight %;
(b) an intermolecular composition distribution of greater than or equal to 75%;
(c) a Tm in the range of from about 25° C. to about 110° C.;
(d) a Hf in the range of from about 0.5 to about 70 J/g;
(e) a Mw/Mn in the range of from about 1.2 to about 4.5; and
(f) a MFR in the range of from about 0.1 to about 40 g/10 min; and
wherein each layer is oriented to the same or different extents, and the layers are combined to form the multilayer polymeric film.

25. A method for forming the multilayer polymeric film comprising:
(1) forming at least one layer A by extruding a first polymeric resin comprising propylene-derived units to form an extrudate;
wherein the first polymeric resin has:
(i) a propylene derived unit content of greater than 90 weight %, based on the weight of the first polymeric resin;
(ii) a Tm of greater than 120° C.;
(iii) a MFR in the range of from about 0.1 to about 100 g/10 min; and
(2) forming at least one layer B by extruding a second polymeric resin comprising ethylene-derived units to form an extrudate;
wherein the second polymeric resin has:
(i) a density in the range of from about 0.905 to about 0.980 g/cm³;
(ii) an ethylene derived unit content of greater than 50 weight %, based on the weight of the second polymeric resin; and
wherein at least one of layers A and B further comprises at least one copolymer of propylene derived units and at least one C₂, and C₄ to C₁₀ alpha-olefin derived units, the copolymer having:
(a) a C₂, and/or C₄ to C₁₀ alpha-olefin derived unit content in the range of about 5 to about 30 weight %;
(b) an intermolecular composition distribution of greater than or equal to 75%;
(c) a Tm in the range of from about 25° C. to about 110° C.;
(d) a Hf in the range of from about 0.5 to about 70 J/g;
(e) a Mw/Mn in the range of from about 1.2 to about 4.5; and
(f) a MFR in the range of from about 0.1 to about 40 g/10 min; and
wherein each layer is oriented to the same or different extents;
wherein the orientation comprises:
(a) inflating each extrudate to form a first bubble;
(b) cooling and collapsing the first bubble to form a primary tube;
(c) heating the primary tube;
(d) inflating the primary tube to form a second bubble, wherein the second bubble at least partially biaxially orients the film; and
(e) cooling and collapsing the second bubble; and
(3) combining the layers to form the multilayer polymeric film.

26. The method of claim 25, wherein the copolymer of propylene derived units and one or more C₂, and C₄ to C₁₀ alpha-olefin derived units is made using a metallocene catalyst.

27. The method of claim 25, wherein the layers are laminated, by extrusion lamination, to form the multilayer polymeric film.

28. The method of claim 25, wherein the layers are co-extruded to form the multilayer polymeric film.

29. An article comprising the multilayer polymeric film of any of claims 1 to 23.

30. A packaging film comprising the multilayer polymeric film of any of claims 1 to 23.

31. The packaging film of claim 30, wherein the packaging film is a shrink wrap film.
